(19) United States
(12) Patent Application Publication
(10) Pub. No.: US 2024/0297734 A1
(43) Pub. Date: Sep. 5, 2024

(54) COMMUNICATION APPARATUS

(71) Applicant: SHARP KABUSHIKI KAISHA, Sakai City, Osaka (JP)

(72) Inventors: ATSUSHI SHIRAKAWA, Sakai City, Osaka (JP); RYOTA YAMADA, Sakai City, Osaka (JP); Takuhiro SATO, Sakai City, Osaka (JP); HIROMICHI TOMEBA, Sakai City, Osaka (JP); HIDEO NAMBA, Sakai City, Osaka (JP)

(21) Appl. No.: 18/572,943

(22) PCT Filed: Jun. 24, 2022
(86) PCT No.: PCT/JP2022/025417

§ 371 Date: Dec. 21, 2023

(30) Foreign Application Priority Data
Jun. 29, 2021 (JP) 2021-107209

(51) Int. Cl. H04L 1/00

(52) U.S. Cl. CPC H04L 1/0057; H04L 1/0061; H04L 1/0068

(57) ABSTRACT

In the IEEE 802.11be standardization activities, application of wireless LAN communication technologies to an application requiring high reliability and low latency such as a Time Sensitive Network (TSN) has also been considered as a standardization target range. The transmission quality resulting from time diversity can be improved, and highly reliable communication can be realized by introducing HARQ, However, since an overhead time for retransmission is needed, it is not sufficient to realize low latency.

### TECHNICAL FIELD

The present invention relates to a communication apparatus.

This application claims priority to JP 2021-107209 filed on Jun. 29, 2021, the contents of which are incorporated herein by reference.

### BACKGROUND ART

The Institute of Electrical and Electronics Engineers Inc. (IEEE) has been continuously working to update the IEEE 802.11 specification that is a wireless Local Area Network (LAN) standard in order to achieve a higher speed and frequency efficiency in wireless LAN communication. In a wireless LAN, radio communication can be performed using unlicensed bands that can be used without permission (license) by nations or regions. For applications for individuals including household applications, Internet access from residences is wirelessly established by, for example, including a wireless LAN access point function in line termination apparatuses for connection to a Wide AreaNetwork (WAN) line such as the Internet or connecting a wireless LAN access point apparatus to a line termination apparatus. In other words, wireless LAN station apparatuses (STAs) such as smartphones and PCs can connect to wireless LAN access point apparatuses to access the Internet.

Designing of the specification of IEEE 802.11ax was completed in February 2021, and wireless LAN devices that are compliant with the specification and communication apparatuses such as smartphones and Personal Computers (PCs) equipped with wireless LAN devices have appeared on the market as products that are compliant with Wi-Fi 6 (trade name; a name for IEEE-802.11ax compliant products certified by the Wi-Fi Alliance). In addition, activities for standardizing IEEE 802.11be as a standard to succeed IEEE 802.11ax have been started. With the rapid spread of wireless LAN devices, further improvement in throughput per user in environments where wireless LAN devices are densely installed has been studied in the standardization of IEEE 802.11be.

In the IEEE 802.11 standard, error control was introduced as a technique for speeding up the throughput. Error control is roughly divided into Forward Error Correction (FEC) and Automatic repeat request (ARQ). Forward error correction is a scheme in which an error caused in a transmission path is corrected on the reception side using an error correction code and a retransmission request to the transmission side does not need to be made in a case that a codeword block has been accurately recovered. Although the capability of error correction is improved by increasing the proportion of redundant bits in a codeword, this has trade-offs such as an increased amount of decoding processing, reduced transmission efficiency, or the like. On the other hand, ARQ is a scheme that requests the transmission side to retransmit a codeword block that has not been accurately decoded on the reception side. An error of the codeword block at the time of the decoding is detected through Medium Access Control (MAC) on the reception side and is discarded without being accumulated in a buffer. An Acknowledgement (ACK) is sent to the transmission side in a case that the codeword block has been decoded normally, while a Negative Acknowledgement (NACK) is sent to the transmission side in a case that an error of the codeword block has been detected. Processing of retransmitting the codeword block is performed by ARQ in a case that a NACK is transmitted to the transmission side or in a case that an ACK has not been transmitted to the transmission side for a certain period of time. In addition to error control in the above-mentioned IEEE 802.11 standard, Hybrid ARQ (HARQ) corresponding to a combination of a forward error correction code and ARQ has been studied in IEEE 802.11be standardization activities. For HARQ, chase combination for improving a Signal to Noise power ratio (SNR) of a reception signal by transmitting the same codeword blocks at the time of retransmission and combining the codeword blocks on the reception side and Incremental Redundancy (IR) combination for enhancing error correction decoding capability on the reception side by newly transmitting a redundancy signal (parity signal) at the time of retransmission have widely been studied.

According to IEEE 802.11n and following standards, a mechanism of frame aggregation has been introduced as a throughput speed-up technology through reduction of overheads. Frame aggregation is roughly classified into Aggregated MAC Service Data Unit (A-MSDU) and Aggregated MAC Protocol Data Unit (A-MPDU). While the frame aggregation enables transmission of a large amount of data at once and improves the transmission efficiency, it increases the probability of a transmission error. Thus, IEEE 802.11ax and following standards are expected to have efficient error control on each MPDU in addition to improvement of transmission efficiency through frame aggregation as the main elemental technologies for speeding up throughput. Accordingly, in the IEEE 802.11be standardization activities, time diversity obtained by the HARQ is expected to improve transmission quality.

### CITATION LIST

### Non Patent Literature

NPL 1: IEEE 802.11-19/1578-00-0be, September 2018
NPL 2: IEEE 802.11-20/482-01-0be, June 2020

### SUMMARY OF INVENTION

### Technical Problem

In the IEEE 802.11be standardization activities, application of wireless LAN communication technologies to an application requiring high reliability and low latency such as a Time Sensitive Network (TSN) has also been considered as a standardization target range. The transmission quality resulting from time diversity can be improved, and highly reliable communication can be realized by introducing HARQ. However, since an overhead time for retransmission is needed, it is not sufficient to realize low latency.

The present invention has been made in view of such circumstances, and discloses a communication apparatus and a communication method that enable low-latency communication in addition to highly-reliable communication by using a method different from the implementation of conventional HARQ that is retransmission in the time axis direction.

### Solution to Problem

A communication apparatus and a communication method according to the present invention for solving the aforementioned problem are as follows.

(1) That is, a communication apparatus according to an aspect of the present invention is a communication apparatus that communicates on a radio channel, the communication apparatus including a coder that encodes a data block to generate a coded block, a frame generator that generates a frame including the coded block, and a transmitter that transmits the frame, in which the radio channel includes multiple radio sub-channels, the coder generates one or two or more coded blocks from the data block, and the frame generator adds a header holding the same identifier to the coded blocks, and allocates the coded blocks to the different radio sub-channels.

(2) In addition, in the communication apparatus according to an aspect of the present invention is described in (1), the respective radio sub-channels may have equal bandwidths.

(3) In addition, in the communication apparatus according to an aspect of the present invention is described in (1), a bandwidth of the radio sub-channels may be equal to a bandwidth of preamble puncturing.

(4) In addition, in the communication apparatus according to an aspect of the present invention is described in (1), the coded blocks allocated to each of the radio sub-channels may be generated from the same data block and have different parity bit sequences.

(5) In addition, in the communication apparatus according to an aspect of the present invention is described in (1), the coded blocks allocated to each of the radio sub-channels may be generated from the same data block and have the same parity bit sequence.

(6) In addition, a communication apparatus according to an aspect of the present invention is a communication apparatus that communicates on a radio channel, the communication apparatus including a coder that encodes a data block to generate a coded block, a frame generator that generates a frame including the coded block, and a transmitter that transmits the frame, in which the radio channel includes multiple radio sub-channels, the coder generates one or two or more coded blocks from the data block, and the frame generator adds a header holding the same identifier to the coded blocks, and allocates the coded blocks to the same radio sub-channel.

(7) In addition, a communication apparatus according to an aspect of the present invention is a communication apparatus that communicates on a radio channel, the communication apparatus including a receiver that receives a frame, and a decoder that decodes a coded block included in the frame, in which the radio channel includes multiple radio sub-channels, and the decoder combines coded blocks having the same identifier included in a header of the frames received on each of the radio sub-channels.

### Advantageous Effects of Invention

The present invention can contribute to improvement in highly reliable communication and low-latency communication in the IEEE 802.11 standard.

### BRIEF DESCRIPTION OF DRAWINGS

FIG. 1 is a schematic diagram illustrating examples of splitting radio resources according to an aspect of the present invention.

FIG. 2 is a diagram illustrating examples of a frame structure according to an aspect of the present invention.

FIG. 3 is a diagram illustrating an example of a frame structure according to an aspect of the present invention.

FIG. 4 is a diagram illustrating an example of communication according to an aspect of the present invention.

FIG. 5 is a diagram illustrating a configuration example of a communication system according to an aspect of the present invention.

FIG. 6 is a block diagram illustrating a configuration example of a radio communication apparatus according to an aspect of the present invention.

FIG. 7 is a block diagram illustrating a configuration example of a radio communication apparatus according to an aspect of the present invention.

FIG. 8 is a schematic diagram illustrating an example of a coding scheme according to an aspect of the present invention.

FIG. 9 is a schematic diagram illustrating an example of a modulation and coding scheme according to an aspect of the present invention.

FIG. 10 is a schematic diagram illustrating examples of block length for LDPC coding processing according to an aspect of the present invention.

FIG. 11 is a diagram illustrating a frame transmission and/or reception according to an aspect of the present invention.

FIG. 12 is a diagram illustrating a frame transmission and/or reception according to an aspect of the present invention.

FIG. 13 is a diagram illustrating a frame transmission and/or reception according to an aspect of the present invention.

FIG. 14 is a diagram illustrating a frame transmission and/or reception according to an aspect of the present invention.

FIG. 15 is a diagram illustrating a frame transmission and/or reception according to an aspect of the present invention.

FIG. 16 is a schematic diagram illustrating an example of blocking processing according to an aspect of the present invention.

FIG. 17 is a schematic diagram illustrating an example of blocking processing according to an aspect of the present invention. is a schematic diagram showing a report.

### DESCRIPTION OF EMBODIMENTS

A communication system according to the present embodiment includes an access point apparatus (or also referred to as a base station apparatus) and multiple station apparatuses (or also referred to as terminal apparatuses). The communication system and a network including the access point apparatus and the station apparatus will be referred to as a basic service set (Basic service set (BSS), management range, or cell). In addition, the station apparatus according to the present embodiment can have functions of the access point apparatus. Similarly, the access point apparatus according to the present embodiment can have functions of the station apparatus. Therefore, in a case that a communication apparatus is simply mentioned below, the communication apparatus can indicate both a station apparatus and an access point apparatus.

The base station apparatus and the terminal apparatuses in the BSS are assumed to perform communication based on Carrier sense multiple access with collision avoidance (CSMA/CA). Although the present embodiment is intended for an infrastructure mode in which a base station apparatus communicates with multiple terminal apparatuses, the method of the present embodiment can also be performed in an ad hoc mode in which terminal apparatuses perform communication directly with each other. In the ad hoc mode, a terminal apparatus substitutes for a base station apparatus to form a BSS. The BSS in the ad hoc mode may also be referred to as an Independent Basic Service Set (IBSS). In the following description, a terminal apparatus that forms an IBSS in the ad hoc mode can also be considered to be a base station apparatus. The method of the present embodiment can also be implemented in Wi-Fi Direct (trade name) in which terminal apparatuses directly communicate with each other. In the Wi-Fi Direct, a terminal apparatus substitutes for a base station apparatus to form a Group. In the following description, a terminal apparatus serving as a Group owner that forms a Group in Wi-Fi Direct can also be regarded as a base station apparatus.

In an IEEE 802.11 system, each apparatus can transmit transmission frames of multiple frame types in a common frame format. Each of the transmission frames is defined as a Physical (PHY) layer, a Medium access control (MAC) layer, or a Logical Link Control (LLC) layer. The physical layer will also be referred to as a PHY layer, and the MAC layer will also be referred to as a MAC layer.

A transmission frame of the PHY layer will be referred to as a physical protocol data unit (PHY protocol data unit (PPDU) or physical layer frame). A PPDU includes a physical layer header (PHY header) including header information and the like for performing signal processing in the physical layer, a physical service data unit (PHY service data unit (PSDU) or MAC layer frame) that is a data unit processed in the physical layer, and the like. The PSDU can include an Aggregated MAC protocol data unit (MPDU) (A-MPDU) in which multiple MPDUs serving as retransmission units in a wireless section are aggregated.

A PHY header includes a reference signal such as a Short training field (STF) used for detection, synchronization, and the like of signals, a Long training field (LTF) used for obtaining channel information for demodulating data, and the like and a control signal such as a Signal (SIG) including control information for demodulating data. In addition, STFs are classified into a Legacy-STF (L-STF), a High throughput-STF (HT-STF), a Very high throughput-STF (VHT-STF), a High efficiency-STF (HE-STF), an Extremely High Throughput-STF (EHT-STF), and the like depending on corresponding standards, and LTFs and SIGs are also similarly classified into an L-LTF, an HT-LTF, a VHT-LTF, an HE-LTF, an L-SIG, an HT-SIG, a VHT-SIG, an HE-SIG, and an EHT-SIG. The VHT-SIG is further classified into VHT-SIG-A1, VHT-SIG-A2, and VHT-SIG-B. Similarly, the HE-SIG is classified into HE-SIG-A1 to 4 and HE-SIG-B. In addition, on the assumption of technology update in the same standard, a Universal SIGNAL (U-SIG) field including additional control information can be included.

Furthermore, the PHY header can include information for identifying a BSS of a transmission source of the transmission frame (hereinafter, also referred to as BSS identification information). The information for identifying a BSS can be, for example, a Service Set Identifier (SSID) of the BSS or a MAC address of a base station apparatus of the BSS. In addition, the information for identifying a BSS can be a value unique to the BSS (e.g., a BSS color, etc.) other than an SSID or a MAC address.

The PPDU is modulated in accordance with the corresponding standard. In the IEEE 802.11n standard, for example, the PPDU is modulated into an Orthogonal frequency division multiplexing (OFDM) signal.

The MPDU includes a MAC layer header (MAC header) including header information and the like for performing signal processing in the MAC layer, a MAC service data unit (MSDU) that is a data unit processed in the MAC layer or a frame body, and a Frame check sequence (FCS) for checking whether there is an error in the frame. In addition, multiple MSDUs can be aggregated as an Aggregated MSDU (A-MSDU).

The frame types of transmission frames of the MAC layer are roughly classified into three frame types, namely a management frame for managing a state in which apparatuses are connected, a control frame for managing a state in which apparatuses communicate with each other, and a data frame including actual transmission data, and each frame type is further classified into multiple subframe types. The control frame includes a reception completion notification (Acknowledge (Ack)) frame, a transmission request (Request to send (RTS)) frame, a reception preparation completion (Clear to send (CTS)) frame, and the like. The management frame includes a Beacon frame, a Probe request frame, a Probe response frame, an Authentication frame, an Association request frame, an Association response frame, and the like. The data frame includes a Data frame, a polling (CF-poll) frame, and the like. Each apparatus can recognize the frame type and the subframe type of a received frame by interpreting the content of the frame control field included in the MAC header.

Note that an Ack may include a Block Ack. A Block Ack can give a reception completion notification to multiple MPDUs. In addition, the Ack may include a Multi STA Block Ack (M-BA) including a reception completion notification for multiple communication apparatuses.

The beacon frame includes a Field in which a periodicity at which a beacon is transmitted (Beacon interval) and an SSID are described. A base station apparatus can periodically broadcast a beacon frame within a BSS, and each terminal apparatus can recognize the base station apparatus around the terminal apparatus by receiving a beacon frame. The action of the terminal apparatus recognizing the base station apparatus based on the beacon frame broadcast from the base station apparatus is referred to as “Passive scanning”. On the other hand, the action of the terminal apparatus searching for the base station apparatus by broadcasting a probe request frame in the BSS is referred to as “Active scanning”. The base station apparatus can transmit a probe response frame in response to the probe request frame, and details described in the probe response frame are equivalent to those in the beacon frame.

A terminal apparatus recognizes a base station apparatus and then performs association processing with respect to the base station apparatus. The connection process is classified into an Authentication procedure and an Association procedure. A terminal apparatus transmits an authentication frame (an authentication request) to a base station apparatus that the terminal apparatus desires to connect with. Once the base station apparatus receives the authentication frame, then the base station apparatus transmits, to the terminal apparatus, an authentication frame (authentication response) including a status code indicating whether authentication can be made for the terminal apparatus. The terminal apparatus can determine whether the terminal apparatus has been authenticated by the base station apparatus by interpreting the status code described in the authentication frame. Note that the base station apparatus and the terminal apparatus can exchange the authentication frame multiple times.

After the authentication procedure, the terminal apparatus transmits an association request frame to the base station apparatus in order to perform the association procedure. Once the base station apparatus receives the association request frame, the base station apparatus determines whether to allow association of the terminal apparatus and transmits an association response frame to signal the intent to the terminal apparatus. In the association response frame, an Association identifier (AID) for identifying the terminal apparatus is described in addition to the status code indicating whether to perform the association process. The base station apparatus can manage multiple terminal apparatuses by configuring different AIDs for the terminal apparatuses for which the base station apparatus has allowed association.

After the association process is performed, the base station apparatus and the terminal apparatus perform actual data transmission. In the IEEE 802.11 system, a Distributed Coordination Function (DCF), a Point Coordination Function (PCF), and mechanisms in which the aforementioned mechanisms are enhanced (an Enhanced distributed channel access (EDCA) or a Hybrid coordination function (HCF), and the like) are defined. Although a case that the base station apparatus transmits signals to the terminal apparatus using the DCF will be described below as an example, the description also applies to a case that the terminal apparatus transmits signals to the base station apparatus using the DCF.

In the DCF, the base station apparatus and the terminal apparatus perform Carrier sensing (CS) for checking the usage state of a radio channel in the surroundings of the apparatuses prior to communication. For example, in a case that the base station apparatus serving as a transmitting station receives a signal of a higher level than a predetermined Clear channel assessment level (CCA level) on a radio channel, transmission of transmission frames on the radio channel is delayed. Hereinafter, a state in which a signal at a level that is equal to or higher than the CCA level is detected on the radio channel will be referred to as a busy (Busy) state, and a state in which a signal at a level that is equal to or higher than the CCA level is not detected will be referred to as an idle (Idle) state. In this manner, CS performed based on power of a signal actually received by each apparatus (reception power level) is called physical carrier sensing (physical CS). Note that a CCA level is also called a carrier sense level (CS level) or a CCA threshold (CCAT). Note that in a case that a signal at a level that is equal to or higher than the CCA level is detected, the base station apparatus and the terminal apparatus start to perform an operation of demodulating at least a signal of the PHY layer.

The base station apparatus performs carrier sensing in an Inter frame space (IFS) in accordance with the type of transmission frame to be transmitted and determines whether the radio channel is in a busy state or an idle state. A period in which the base station apparatus performs carrier sensing varies depending on the frame type and the subframe type of a transmission frame to be transmitted by the base station apparatus. In the IEEE 802.11 system, multiple IFSs with different periods are defined, including a short frame interval (Short IFS (SIFS)) used for a transmission frame with the highest priority given, a polling frame interval (PCF IFS (PIFS)) used for a transmission frame with a relatively high priority, a distribution control frame interval (DCF IFS (DIFS)) used for a transmission frame with the lowest priority, and the like. In a case that the base station apparatus transmits a data frame with a DCF, the base station apparatus uses a DIFS.

The base station apparatus waits by DIFS and then further waits for a random backoff time to prevent frame collision. In the IEEE 802.11 system, a random backoff time called a Contention window (CW) is used. CSMA/CA is based on the assumption that a transmission frame transmitted by a certain transmitting station is received by a receiving station in a state in which there is no interference from other transmitting stations. Therefore, in a case that transmitting stations transmit transmission frames at the same timing, the frames collide against each other, and the receiving station cannot receive them properly. Thus, each transmitting station waits for a randomly configured time before starting transmission, and thus collision of frames can be avoided. In a case that the base station apparatus determines through carrier sensing that a radio channel is in the idle state, the base station apparatus starts to count down a CW, acquires a transmission right for the first time after the CW becomes zero, and can transmit a transmission frame to the terminal apparatus. Note that, in a case that the base station apparatus determines through carrier sensing that the radio channel is in the busy state during the count-down of the CW, the base station apparatus stops the count-down of the CW. Thereafter, in a case that the radio channel is in the idle state, then the base station apparatus restarts count-down of the remaining CW succeeding to the previous IFS.

Next, details of frame reception will be described. A terminal apparatus that is a receiving station receives a transmission frame, interprets the PHY header of the transmission frame, and demodulates the received transmission frame. Then, the terminal apparatus interprets the MAC header of the demodulated signal and thus can recognize whether the transmission frame is addressed to the terminal apparatus itself. Note that the terminal apparatus can also determine the destination of the transmission frame based on information described in the PHY header (e.g., a group identifier (Group identifier (GID), Group ID) described in VHT-SIG-A).

In a case that the terminal apparatus determines that the received transmission frame was addressed to the terminal apparatus and has successfully demodulated the transmission frame without any error, the terminal apparatus is to transmit an ACK frame indicating the proper reception of the frame to the base station apparatus that is the transmitting station. The ACK frame is one of transmission frames with the highest priority transmitted only after a wait for the SIFS period (with no random backoff time). The base station apparatus ends the series of communication operations with the reception of the ACK frame transmitted from the terminal apparatus. Note that, in a case that the terminal apparatus is not able to receive the frame properly, the terminal apparatus transmits no ACK. Thus, in a case that no ACK frame has been received from the receiving station for a certain period of time (the length of SIFS+ACK frame) after the transmission of the frame, the base station apparatus considers that the communication has failed and ends the communication. In this manner, the end of a single communication operation (also called a burst) in the IEEE 802.11 system is to be determined based on whether an ACK frame is received, except for special cases such as a case of transmission of a broadcast signal such as a beacon frame, a case that fragmentation for splitting transmission data is used, or the like.

In a case that the terminal apparatus determines that the received transmission frame is not addressed to the terminal apparatus itself, the terminal apparatus configures a Network allocation vector (NAV) based on the length of the transmission frame described in the PHY header or the like. The terminal apparatus does not attempt communication during the period configured in the NAV. In other words, because the terminal apparatus performs the same operation as in the case that the terminal apparatus determines the radio channel is in the busy state through physical CS for the period configured in the NAV, the communication control based on the NAV is also called virtual carrier sensing (virtual CS). The NAV is also configured with a transmission request (Request to send (RTS)) frame or a reception preparation completion (Clear to send (CTS)) frame, which are introduced to solve a hidden terminal problem in addition to the case that the NAV is configured based on the information described in the PHY header.

Unlike the DCF in which each apparatus performs carrier sensing and autonomously acquires the transmission right, in the PCF, a control station called a Point coordinator (PC) controls the transmission right of each apparatus within a BSS. In general, a base station apparatus serves as a PC and acquires the transmission right with respect to a terminal apparatus within a BSS.

A communication period using the PCF includes a Contention free period (CFP) and a Contention period (CP). Communication is performed based on the aforementioned DCF during a CP, and a PC controls the transmission right during a CFP. The base station apparatus serving as a PC broadcasts a beacon frame with description of a CFP Max duration (CFP) and the like in a BSS prior to communication with a PCF. Note that the PIFS is used for transmission of the beacon frame broadcast at the time of a start of transmission of the PCF, and the beacon frame is transmitted without waiting for a CW. The terminal apparatus that has received the beacon frame configures the CFP described in the beacon frame in a NAV. Hereinafter, the terminal apparatus can acquire the transmission right only in a case that a signal (e.g., a data frame including CF-poll) for signaling the acquisition of the transmission right transmitted by the PC is received, until the NAV elapses or a signal (e.g., a data frame including CF-end) broadcasting the end of the CFP in the BSS is received. Note that, because no frame collision occurs inside the same BSS during the CFP, each terminal apparatus does not take a random backoff time used in the DCF.

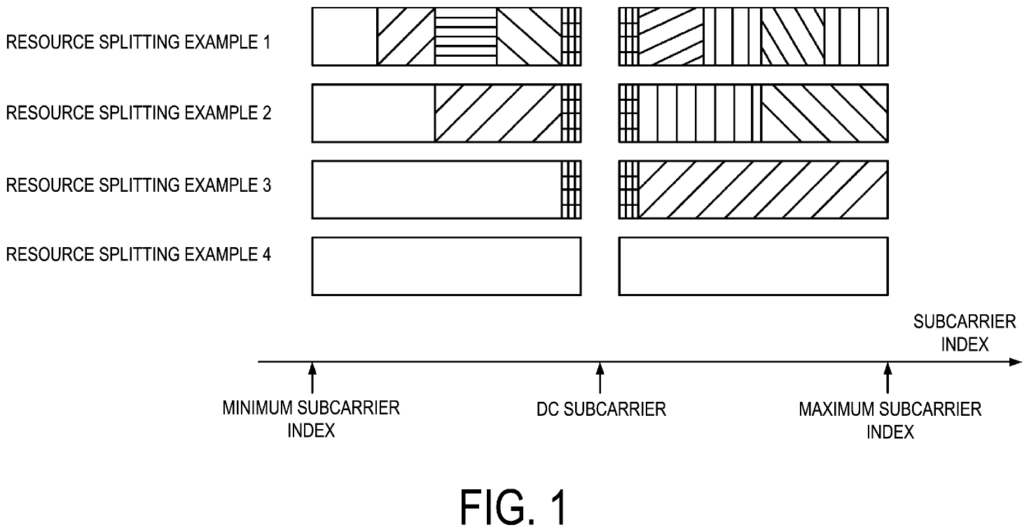

A radio medium can be split into multiple Resource units (RUs). FIG. 1 is a schematic diagram illustrating an example of a split state of a radio medium. In the resource splitting example 1, for example, a radio communication apparatus can split a frequency resource (subcarrier) that is a radio medium into nine RUs. Similarly, in the resource splitting example 2, the radio communication apparatus can split a subcarrier that is a radio medium into five RUs. It is a matter of course that the resource splitting examples illustrated in FIG. 1 are merely examples, and for example, each of the plurality of RUs can include a different number of subcarriers. The radio medium that is split into RUs can also include not only frequency resources but also spatial resources. The radio communication apparatus (e.g., an access point apparatus) can transmit frames to multiple terminal apparatuses (e.g., multiple station apparatuses) at the same time by allocating frames directed to different terminal apparatuses to each RU. The access point apparatus can describe information (Resource allocation information) indicating the split state of the radio medium as common control information in the PHY header of the frame transmitted by the access point apparatus. Moreover, the access point apparatus can describe information (resource unit assignment information) indicating a RU where a frame directed to each station apparatus is allocated as unique control information in the PHY header of the frame transmitted by the access point apparatus.

Multiple terminal apparatuses (e.g., multiple station apparatuses) can transmit frames at the same time by transmitting the frames allocated to the RUs allocated to the terminal apparatuses. The plurality of station apparatuses can perform frame transmission after waiting for a predetermined period of time after receiving the frame (Trigger frame (TF)) including trigger information transmitted from the access point apparatus. Each station apparatus can recognize the RU allocated to the station apparatus based on the information described in the TF. Each station apparatus can also acquire the RU through a random access with reference to the TF.

The access point apparatus can allocate multiple RUs to one station apparatus at the same time. The multiple RUs can include continuous subcarriers or can include discontinuous subcarriers. The access point apparatus can transmit one frame using multiple RUs allocated to one station apparatus or can transmit multiple frames allocated to different RUs. At least one of the multiple frames can be a frame including common control information for multiple terminal apparatuses that transmit Resource allocation information.

One station apparatus can be allocated multiple RUs by the access point apparatus. The station apparatus can transmit one frame using the plurality of allocated RUs. In addition, the station apparatus can use multiple allocated RUs to perform transmission of multiple frames allocated to different RUs. The plurality of frames each can be a frame of a different frame type.

The access point apparatus can also allocate multiple AIDs to one station apparatus. The access point apparatus can allocate an RU to each of the plurality of AIDs allocated to the one station apparatus. The access point apparatus can transmit mutual different frames using the RUs allocated to the plurality of AIDs allocated to the one station apparatus. The different frames each can be a frame of a different frame type.

The one station apparatus can also be allocated multiple AIDs by the access point apparatus. The one station apparatus can be allocated an RU to each of the multiple AIDs allocated to the one station apparatus. The one station apparatus recognizes each of the RUs allocated to the corresponding one of the multiple AIDs allocated to the one station apparatus as RUs allocated to the one station apparatus and can transmit one frame using the multiple allocated RUs. Also, the one station apparatus can transmit multiple frames using the multiple allocated RUs. At this time, the multiple frames can be transmitted with information indicating the AIDs associated with the respective allocated RUs described therein. The access point apparatus can transmit the different frames using the RUs allocated to the multiple AIDs allocated to the one station apparatus. The different frames can be frames of different frame types.

Hereinafter, the base station apparatus and the terminal apparatuses may be collectively referred to as radio communication apparatuses or communication apparatuses. Information exchanged in a case that a certain radio communication apparatus performs communication with another radio communication apparatus may also be referred to as data. In other words, radio communication apparatuses include a base station apparatus and a terminal apparatus.

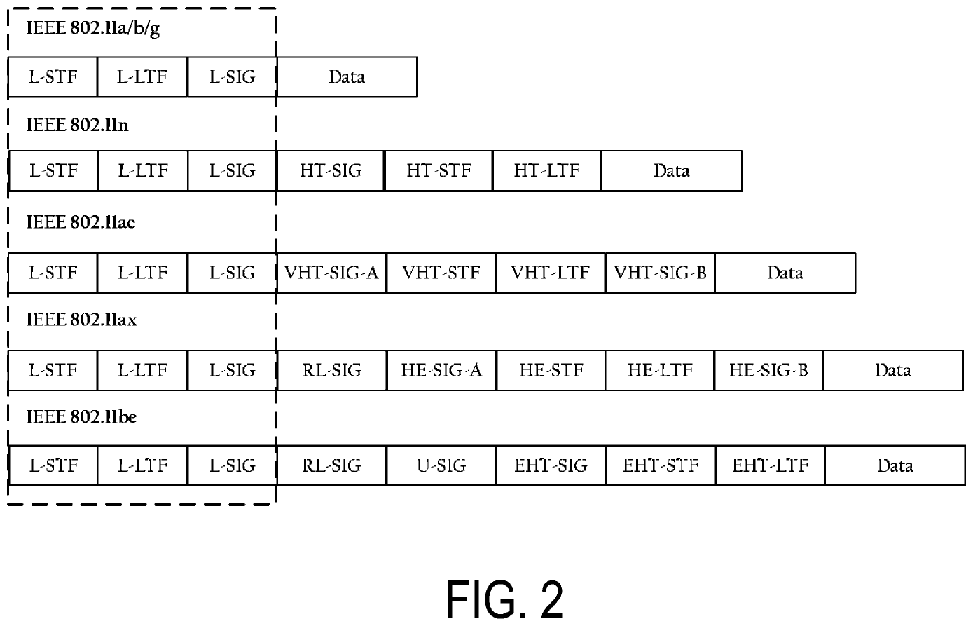

A radio communication apparatus includes any one of or both the function of transmitting a PPDU and a function of receiving a PPDU. FIG. 2 is a diagram illustrating an example of a configuration of a PPDU transmitted by a radio communication apparatus. A PPDU that is compliant with the IEEE 802.11a/b/g standard includes L-STF, L-LTF, L-SIG, and a data frame (a MAC Frame, a MAC frame, a payload, a data part, data, information bits, and the like). A PPDU that is compliant with the IEEE 802.11n standard includes L-STF, L-LTF, L-SIG, HT-SIG, HT-STF, HT-LTF, and a data frame. A PPDU that is compliant with the IEEE 802.11ac standard includes some or all of L-STF, L-LTF, L-SIG, VHT-SIG-A, VHT-STF, VHT-LTF, VHT-SIG-B, and a MAC frame. A PPDU of the IEEE 802.11 ax standard includes some or all of L-STF, L-LTF, L-SIG, RL-SIG in which L-SIG is temporally repeated, HE-SIG-A, HE-STF, HE-LTF, HE-SIG-B, and a data frame. A PPDU studied in the IEEE 802.11be standard includes some or all of L-STF, L-LTF, L-SIG, RL-SIG, U-SIG, EHT-SIG, EHT-STF, EHT-LTF, and a data frame.

L-STF, L-LTF, and L-SIG surrounded by the dashed line in FIG. 2 are configurations commonly used in the IEEE 802.11 standards (hereinafter, L-STF, L-LTF, and L-SIG will also be collectively referred to as an L-header). For example, a radio communication apparatus that is compliant with the IEEE 802.11a/b/g standard can appropriately receive an L-header inside a PPDU that is compliant with the IEEE 802.11n/ac standard. The radio communication apparatus that is compliant with the IEEE 802.11a/b/g standard can receive the PPDU that is compliant with the IEEE 802.11n/ac standard, regarding it as a PPDU that is compliant with the IEEE 802.11a/b/g standard.

However, because the radio communication apparatus that is compliant with the IEEE 802.11a/b/g standard cannot demodulate the PPDU that is compliant with the IEEE 802.11n/ac standard following the L-header, it is not possible to demodulate information about a Transmitter Address (TA), a Receiver Address (RA), and a Duration/ID field used for configuring a NAV.

As a method for the radio communication apparatus that is compliant with the IEEE 802.11a/b/g standard to appropriately configure a NAV (or perform a receiving operation for a predetermined period of time), IEEE 802.11 prescribes a method of inserting Duration information into L-SIG. Information about a transmission speed in L-SIG (a RATE field, an L-RATE field, an L-RATE, L_DATARATE, and an L_DATARATE field), information about a transmission period (a LENGTH field, an L-LENGTH field, and L-LENGTH) are used by the radio communication apparatus that is compliant with the IEEE 802.11a/b/g standard to appropriately configure a NAV.

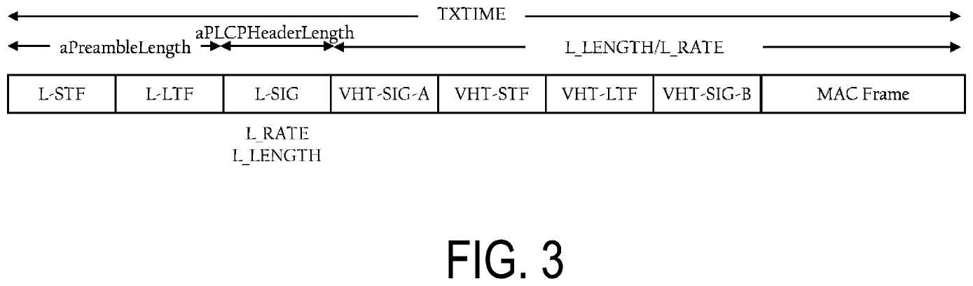

FIG. 3 is a diagram illustrating an example of a method of Duration information inserted into L-SIG. Although a PPDU configuration that is compliant with the IEEE 802.11ac standard is illustrated as an example in FIG. 3, the PPDU configuration is not limited thereto. A PPDU configuration that is compliant with the IEEE 802.11n standard and a PPDU configuration that is compliant with the IEEE 802.11 ax standard may be employed. TXTIME includes information about a length of a PPDU, aPreambleLength includes information about a length of a preamble (L-STF+L-LTF), and aPLCPHeaderLength includes information about a length of a PLCP header (L-SIG). L_LENGTH is calculated based on Signal Extension that is a virtual period configured for compatibility with the IEEE 802.11 standard, Nₒₚₛ related to L-RATE, aSymbolLength that is information about a period of one symbol (a symbol, an OFDM symbol, or the like), aPLCPServiceLength indicating the number of bits included in PLCP Service field, and aPLCPConvolutionalTailLength indicating the number of tail bits of a convolution code. The radio communication apparatus can calculate L_LENGTH and insert L_LENGTH into L-SIG. The radio communication apparatus can also calculate L-SIG Duration. L-SIG Duration indicates information about a PPDU including L_LENGTH and information about a period that is the sum of periods of Ack and SIFS expected to be transmitted by the destination radio communication apparatus in response to the PPDU.

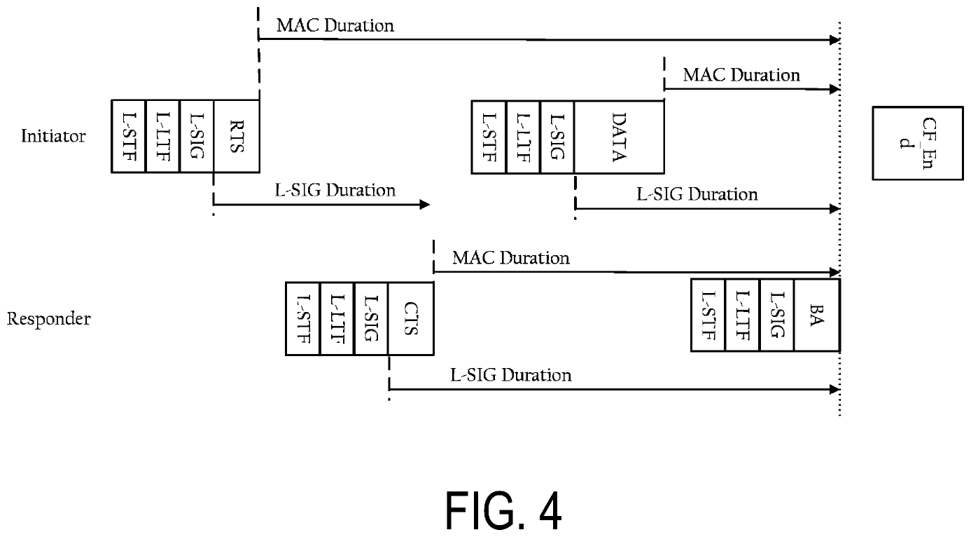

FIG. 4 is a diagram illustrating an example of L-SIG Duration in L-SIG TXOP Protection. DATA (a frame, a payload, data, and the like) include some of or both a MAC frame and a PLCP header. In addition, BA includes Block Ack or Ack. A PPDU includes L-STF, L-LTF, and L-SIG and can further include any one or more of DATA, BA, RTS, or CTS. Although L-SIG TXOP protection using RTS/CTS is illustrated in the example illustrated in FIG. 4, CTS-to-Self may be used. Here, the MAC Duration is a period indicated by a value of the Duration/ID field. Initiator can also transmit a CF_End frame for signaling an end of the L-SIG TXOP Protection period.

Next, a method of identifying a BSS from a frame received by a radio communication apparatus will be described. In order for the radio communication apparatus to identify the BSS from the received frame, the radio communication apparatus that transmits a PPDU preferably inserts information (BSS color, BSS identification information, a value unique to the BSS) for identifying the BSS into the PPDU, and it is possible to describe information indicating the BSS color in HE-SIG-A.

The radio communication apparatus can transmit L-SIG multiple times (L-SIG Repetition). For example, demodulation accuracy of L-SIG is improved by the radio communication apparatus on the reception side receiving L-SIG transmitted multiple times by using Maximum Ratio Combining (MRC). Moreover, in a case that reception of L-SIG is properly completed using MRC, the radio communication apparatus can interpret the PPDU including the L-SIG as a PPDU that is compliant with the IEEE 802.11ax standard.

Even during the operation of receiving the PPDU, the radio communication apparatus can perform an operation of receiving part of the PPDU other than the corresponding PPDU (e.g., the preamble, L-STF, L-LTF, and the PLCP header prescribed by IEEE 802.11) (also referred to as a double-reception operation). In a case that some PPDUs other than the PPDU are detected during the operation of receiving the PPDU, the radio communication apparatus can update a part of or the entire information about the destination address, the transmission source address, the PPDU, or a DATA period.

An Ack and a BA can also be referred to as a response (a response frame). In addition, a probe response, an authentication response, and an association response can also be referred to as a response.

### 1. First Embodiment

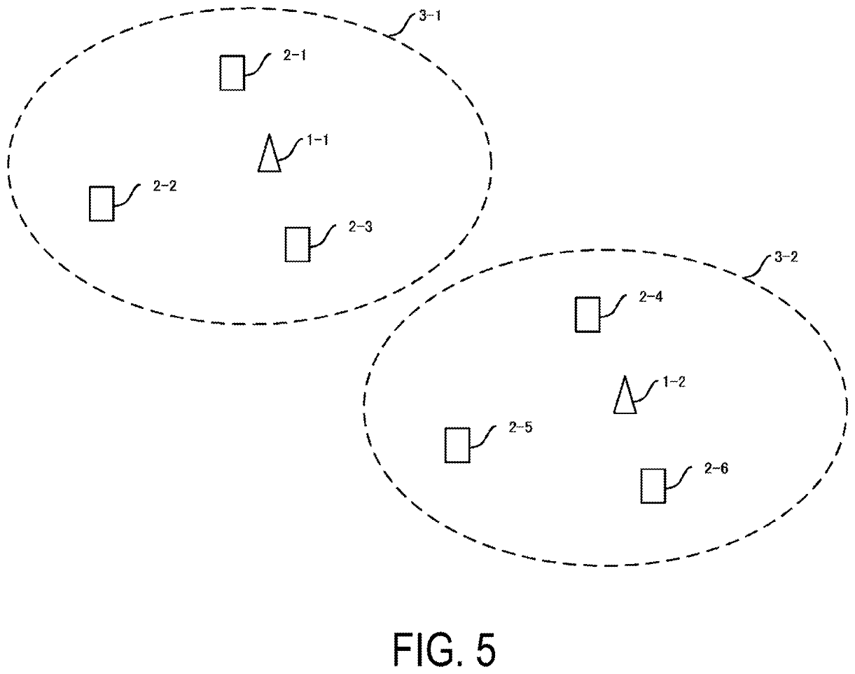

FIG. 5 is a diagram illustrating an example of a radio communication system according to the present embodiment. A radio communication system 3-1 includes a radio communication apparatus 1-1 and radio communication apparatuses 2-1 to 2-3. Note that the radio communication apparatus 1-1 will also be referred to as a base station apparatus 1-1, and the radio communication apparatuses 2-1 to 2-3 will also be referred to as terminal apparatuses 2-1 to 2-3. In addition, each of the radio communication apparatuses 2-1 to 2-3 and each of the terminal apparatuses 2-1 to 2-3 may also be referred to as a radio communication apparatus 2A and a terminal apparatus 2A, respectively, as an apparatus connected to the radio communication apparatus 1-1. The radio communication apparatus 1-1 and the radio communication apparatus 2A are wirelessly connected and are in a state in which they can transmit and/or receive PPDUs to and from each other. The radio communication system according to the present embodiment may also include a radio communication system 3-2 in addition to the radio communication system 3-1. The radio communication system 3-2 includes a radio communication apparatus 1-2 and radio communication apparatuses 2-4 to 2-6. Note that the radio communication apparatus 1-2 will also be referred to as a base station apparatus 1-2 and the radio communication apparatuses 2-4 to 2-6 will also be referred to as terminal apparatuses 2-4 to 2-6. In addition, in addition, each of the radio communication apparatuses 2-4 to 2-6 and each of the terminal apparatuses 2-4 to 2-6 will also be referred to as a radio communication apparatus 2B and a terminal apparatus 2B, respectively, as apparatuses associated to the radio communication apparatus 1-2. Although the radio communication system 3-1 and the radio communication system 3-2 form different BSSs, this does not necessarily mean that Extended Service Sets (ESSs) are different. An ESS indicates a service set forming a Local Area Network (LAN). In other words, radio communication apparatuses belonging to the same ESS can be regarded as belonging to the same network from a higher layer. In addition, BSSs are integrated via a Distribution System (DS) to form an ESS. Note that each of the radio communication systems 3-1 and 3-2 can further include multiple radio communication apparatuses.

In FIG. 5, it is assumed that signals transmitted by the radio communication apparatus 2A reach the radio communication apparatus 1-1 and the radio communication apparatus 2B while the signals do not reach the radio communication apparatus 1-2 in the following description. In other words, in a case that the radio communication apparatus 2A transmits a signal using a certain channel, the radio communication apparatus 1-1 and the radio communication apparatus 2B determine that the channel is in the busy state, whereas the radio communication apparatus 1-2 determines that the channel is in the idle state. In addition, it is assumed that signals transmitted by the radio communication apparatus 2B reach the radio transmission apparatus 1-2 and the radio communication apparatus 2A, but do not reach the radio communication apparatus 1-1. In other words, in a case that the radio communication apparatus 2B transmits a signal using a certain channel, the radio communication apparatus 1-2 and the radio communication apparatus 2A determine that the channel is in the busy state, whereas the radio communication apparatus 1-1 determines that the channel is in the idle state.

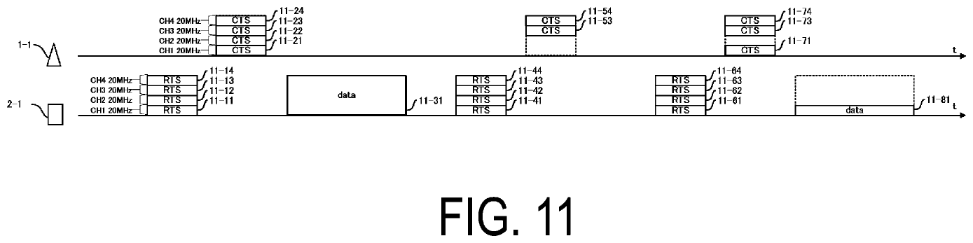

FIG. 11 will be used to further describe that, in the IEEE 802.11 system, acquisition of the transmission right is performed every 20 MHz bandwidth. Note that response frames (Ack, Block Ack, etc.) are not illustrated in FIG. 11. Although a case that the station apparatus transmits a data frame to the access point apparatus will be mainly described in the following description, a case that the access point apparatus transmits a data frame to the station apparatus is also applicable.

For example, it is assumed that IEEE 802.11ax-compliant access point apparatuses constitute a radio communication system that uses the 80 MHz bandwidth in total from a CH1 to a CH4 each of which is of 20 MHz bandwidth. All of the CH1 to the CH4 is also referred to as a system bandwidth or a radio communication channel (or a radio channel). Any one of the CH1 to the CH4 is configured as a primary channel, and the acquisition of the transmission right based on a backoff time count and the carrier sensing in the Primary channel also affects the acquisition of the transmission right in the other channels. For example, in a case that the CH1 is configured as the primary channel, the CH2 neighboring the CH1 is referred to as a Secondary channel, a combination of the CH1 and the CH2 is referred to as a Primary 40 MHz channel, and a combination of the CH3 and the CH4 neighboring the primary 40 MHz channel is referred to as a Secondary 40 MHz channel. In addition, each of the CH1 to the CH4 is referred to as a sub-channel (or a radio sub-channel). A radio channel includes one or more radio sub-channels.

An example of a frame transmission procedure in a case that the station apparatus 2-1 transmits a frame to the access point apparatus 1-1 on the assumption that the primary channel is configured as the CH1 will be described. In a case that carrier sensing is performed in the CH1 after waiting for the random backoff time to determine that the radio channel is in the idle state, the station apparatus 2-1 transmits an RTS frame 11-11 onto the CH1 and transmits equivalent frames as RTS frames 11-12 to 11-14 to the CH2 to the CH4 at the same timing. The access point apparatus 1-1 receiving the RTS frames checks the radio channel conditions of the CH1 to the CH4, and in a case of determining that the radio channel conditions are the idle states, then the access point apparatus 1-1 transmits CTS frames 11-21 to 11-24 indicating the idle states, to the CH1 to the CH4, respectively, and the station apparatus 2-1 receives the CTS frames 11-21 to 11-24. The station apparatus determines that the radio channels of the CH1 to the CH4 are available, and transmits a data frame 11-31. In other words, the entire system bandwidth 80 MHz can be used to transmit the data frames.

On the other hand, even in a case that the station apparatus 2-1 transmits the RTS frame, there may be a case that the CTS frame cannot be received on all of the CH1 to the CH4. For example, that is a case that the access point apparatus 1-1 having received the RTS frames 11-41 to 11-44 on each of the CH1 to the CH4 checks the radio channel conditions to determine that only the CH3 and the CH4 are in the idle states, and transmits the CTS frames (11-53 and 11-54) only to the CH3 and the CH4. In a case of being incapable of receiving the CTS frames on the CH1 which is the primary channel, the station apparatus 2-1 cannot transmit the data frames on any of the CH1 to the CH4. In other words, the determination on whether to transmit the data frames depends on the condition of the primary channel.

As another example, there is a case that the CTS frames are received on the CH1 which is the primary channel but the CTS frames cannot be received on all of the CH1 to the CH4. For example, that is a case that the access point apparatus having received the RTS frames 11-61 to 11-64 on the CH1 to the CH4, respectively, checks the radio channel conditions to determine that only the CH1, CH3, and CH4 are in the idle state, and transmits the CTS frames (11-71, 11-73 and 11-74) to the CH1, CH3, and the CH4. The station apparatus 2-1 is capable of transmitting data frames because it has received the CTS frames on the CH1 that is the primary channel, and ascertains that the CH1, the CH3, and the CH4 are in the idle state.

In this case, in the IEEE standard up to IEEE 802.11ax, it is assumed that the primary channel is in the idle state in order to transmit a frame, the idle state is checked in the order of the secondary 20 MHz channel and the secondary 40 MHz channel, and it is possible to transmit a frame on continuous channels from the primary channel and on a channel in the idle state. To be more specific, if the secondary 20 MHz channel is in an idle state in addition to the primary channel, frame transmission can be performed at least on the primary 40 MHz channel. However, if the secondary 20 MHz channel is busy, frame transmission can only be performed on the primary channel without depending on the state of the secondary 40 MHz channel. Therefore, in FIG. 11, although the CTS frames 11-73 and 11-74 can be received and the CH3 and CH4 are in the idle state, the CH2 is in the busy state and the secondary 20 MHz is determined to be busy, the secondary 40 MHz whose channel is discontinuous with respect to the primary channel cannot be used, and as a result, frames can be transmitted only on the CH1. That is, although the 60 MHz bandwidths of the CH1, CH3, and CH4 of the 80 MHz bandwidths are in the idle state, frame transmission (11-81) can be performed only in the 20 MHz bandwidth of the CH1, and there is a problem in that frequencies cannot be sufficiently and effectively utilized.

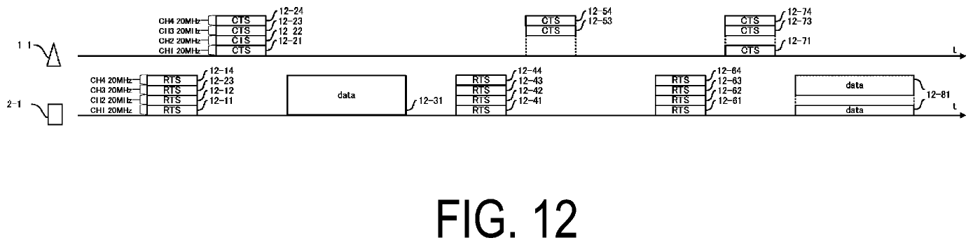

In order to solve the above-described problem that the frequencies are not sufficiently and effectively utilized, a mechanism called Preamble puncturing has been studied in IEEE 802.11be, and will be described with reference to FIG. 12. Note that response frames (Ack, Block Ack, etc.) are not illustrated in FIG. 12. In a case that carrier sensing is performed on the CH1 after waiting for the random backoff time to determine that the radio channel is in the idle state, the station apparatus 2-1 transmits an RTS frame 12-11 on the CH1 and transmits equivalent frames as RTS frames 12-12 to 12-14 to the CH2 to the CH4 at the same timing. In a case that the access point apparatus 1-1 having received the RTS frames checks the radio channel conditions of the CH1 to the CH4 and determines that the radio channel conditions are the idle states, the access point apparatus 1-1 transmits CTS frames 12-21 to 12-24 indicating the idle states to the CH1 to the CH4, respectively, and the station apparatus 2-1 receives the CTS frames. The station apparatus determines that the radio channels of the CH1 to the CH4 are available, and transmits a data frame 12-31. Specifically, the entire channel bandwidth 80 MHz can be used for transmitting the data frame.

On the other hand, even in a case that the station apparatus 2-1 transmits the RTS frame, there may be a case that the CTS frame cannot be received on all of the CH1 to the CH4. For example, that is a case that the access point apparatus 1-1 having received the RTS frames 12-41 to 12-44 on the CH1 to the CH4, respectively, checks the radio channel conditions to determine that only the CH3 and the CH4 are in the idle state, and transmits the CTS frames (12-53 and 12-54) only to the CH3 and the CH4. In a case of being incapable of receiving the CTS frames on the CH1 which is the primary channel, the station apparatus 2-1 cannot transmit the data frames on any of the CH1 to the CH4. Specifically, the determination on whether to transmit the data frames depends on the condition of the primary channel. The operation up to this point is the same as the IEEE standard operation up to IEEE 802.11ax.

A case that, although CTS frames are received on the CH1 that is the primary channel but the CTS frames cannot be received on all of the CH1 to the CH4 will be described. For example, that is a case that the access point apparatus having received RTS frames 12-61 to 12-64 on the CH1 to the CH4, respectively, checks the radio channel conditions to determine that all channels other than the CH2 are in the idle state, and transmits the CTS frames (12-71, 12-73 and 12-74) to the CH1, CH3, and the CH4. The station apparatus 2-1 is capable of transmitting data frames because it has received the CTS frames on the CH1 that is the primary channel, and ascertains that the CH1, the CH3, and the CH4 are in the idle state. In preamble puncturing, the data frames can be transmitted even if sub-channels in the idle state are discontinuous. In this case, a data frame 12-81 can be transmitted using the CH1, the CH3, and the CH4. That is, when the primary channel is in the idle state, frames can be transmitted using the other sub-channels in the idle state. On the same premise, in the standard operation up to IEEE 802.11ax, frames can be transmitted only in the 20 MHz bandwidth of the primary channel in the 80 MHz bandwidth, but in the mechanism of the Preamble puncturing studied in IEEE 802.11be, frames are transmitted in the 60 MHz bandwidth in total of the CH3 and the CH4 that are channels in the idle state in addition to the CH1 that is the primary channel, and thus the frequencies can be utilized more effectively.

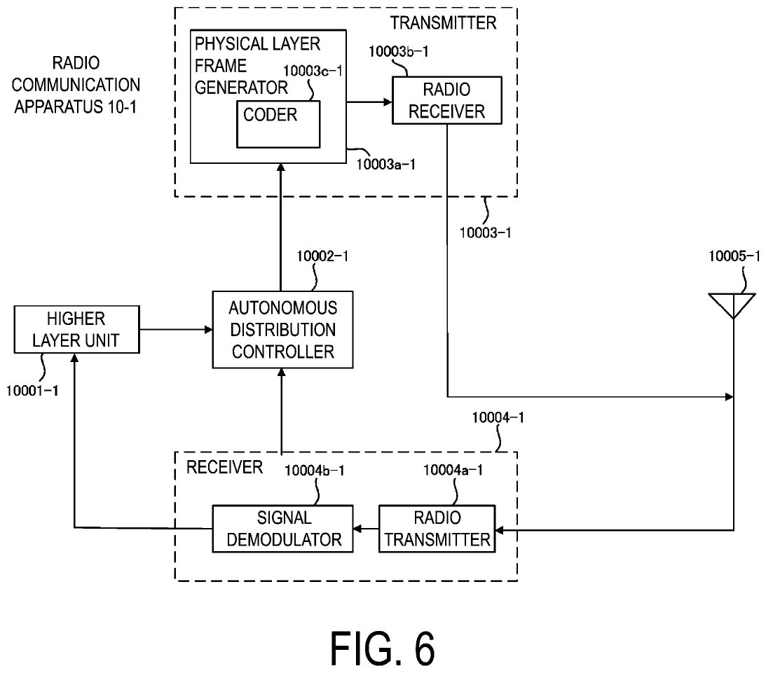

FIG. 6 is a diagram illustrating an example of an apparatus configuration of the radio communication apparatuses 1-1, 1-2, 2A, and 2B (hereinafter, collectively referred to as a radio communication apparatus 10-1 or a station apparatus 10-1 or also simply referred to as a station apparatus). The radio communication apparatus 10-1 includes a higher layer unit (higher layer processing step) 10001-1, an autonomous distribution controller (autonomous distributed control step) 10002-1, a transmitter (transmission step) 10003-1, a receiver (reception step) 10004-1, and an antenna unit 10005-1.

The higher layer processing unit 10001-1 performs information processing for layers higher than the physical layer, for example, the MAC layer and the LLC layer in regard to information (information related to a transmission frame, a Management Information Base (MIB), and the like) handled in the radio communication apparatus itself and a frame received from another radio communication apparatus.

The higher layer unit 10001-1 can signal information related to a frame and traffic transmitted to a radio medium to the autonomous distribution controller 10002-1. The information related to a frame and traffic may be control information included in a management frame such as a beacon, for example, or may be measurement information reported by another radio communication apparatus to the radio communication apparatus itself. Moreover, the information may be control information included in a management frame or a control frame with no limited destinations (the information may be directed to the apparatus, may be directed to another apparatus, may be broadcast, or may be multicast).

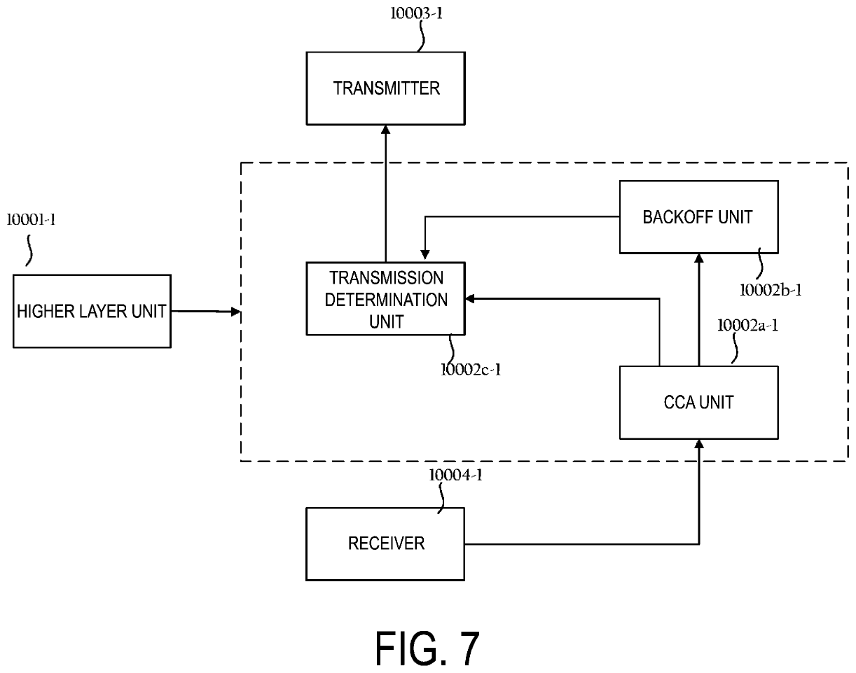

FIG. 7 is a diagram illustrating an example of an apparatus configuration of the autonomous distribution controller 10002-1. The controller 10002-1 includes a CCA unit (CCA step) 10002a-1, a backoff unit (backoff step) 10002b-1, and a transmission determination unit (transmission determination step) 10002c-1.

The CCA unit 10002a-1 can perform determination of a state of a radio resource (including determination of a busy state and an idle state) using any one of or both information about a reception signal power received via the radio resource and information about the reception signal (including information after decoding) signaled from the receiver 10004-1. The CCA unit 10002a-1 can signal the state determination information of the radio resource to the backoff unit 10002b-1 and the transmission determination unit 10002c-1.

The backoff unit 10002b-1 can perform backoff using the state determination information of the radio resource. The backoff unit 10002b-1 has a function of generating a CW and counting down the CW. For example, it is possible to perform counting-down of the CW in a case that the state determination information of the radio resource indicates an idle state, for example, and it is possible to stop the counting-down of the CW in a case that the state determination information of the radio resource indicates a busy state. The backoff unit 10002b-1 can signal the value of the CW to the transmission determination unit 10002c-1.

The transmission determination unit 10002c-1 performs transmission determination using either of or both the state determination information of the radio resource or/and the value of the CW. For example, transmission determination information can be signaled to the transmitter 10003-1 in a case that the state determination information of the radio resource indicates idle and the value of the CW is zero. In addition, the transmission determination information can be signaled to the transmitter 10003-1 in a case that the state determination information of the radio resource indicates idle.

The transmitter 10003-1 includes a physical layer frame generator (physical layer frame generation step) 10003a-1 and a radio transmitter (radio transmission step) 10003b-1. Note that the physical layer frame generator (physical layer frame generation step) may be referred to as a frame generator (frame generation step). The physical layer frame generator 10003a-1 includes a function of generating a physical layer frame (hereinafter, also referred to as a frame or a PPDU) based on the transmission determination information signaled from the transmission determination unit 10002c-1. The physical layer frame generator 10003a-1 includes a coder (coding step) that performs error correction coding processing on data received from the higher layer (10003c-1) and generates a coded block. In addition, the physical layer frame generator 10003a-1 also includes a function of performing modulation, precoding filter multiplication, and the like. The physical layer frame generator 10003a-1 sends the generated physical layer frame to the radio transmitter 10003b-1.

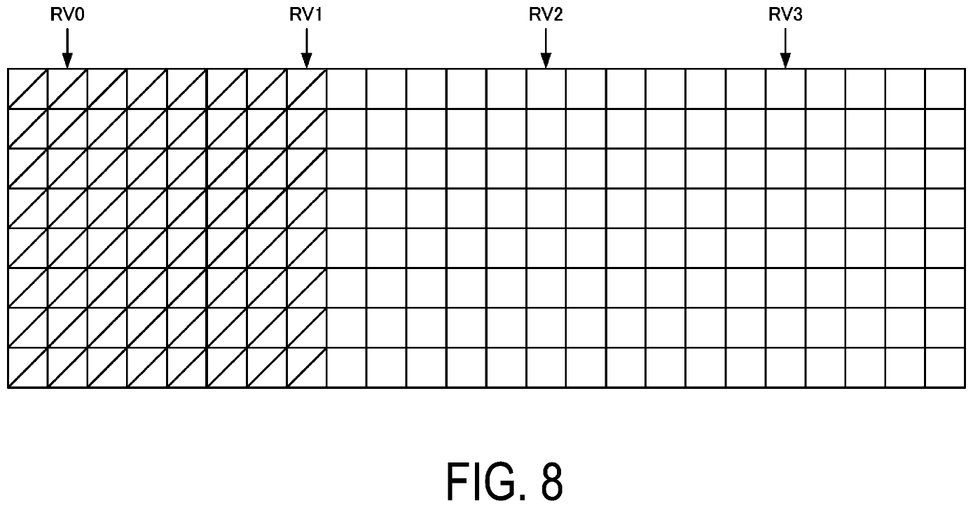

FIG. 8 is a diagram illustrating an example of error correction coding performed by the coder 10003c-1 according to the present embodiment. As illustrated in FIG. 8, an information bit (systematic bit) sequence is mapped in the hatched region and a redundancy bit sequence (parity bit sequence) is mapped in the white region. Bit interleaving is appropriately applied to each of the information bits and the redundancy bits. The physical layer frame generator 10003a-1 can read a necessary number of bits as a start position determined for the mapped bit sequence in accordance with a value of Redundancy Version (RV). Flexible change in coding rate, that is puncturing, is possible by adjusting the number of bits. Note that, although a total of four RVs are illustrated in FIG. 8, the number of options for RV is not limited to a specific value in the error correction coding according to the present embodiment. Station apparatuses need to share positions of RVs. It is needless to say that the method of the error correction coding according to the present embodiment is not limited to the example in FIG. 8, and it is only necessary to employ a method by which the coding rate can be changed and decoding processing on the reception side can be achieved.

For example, the RV may indicate a number of a parity block. The parity block is obtained by splitting a parity bit sequence into one or more blocks. In a case that the number of parity blocks is four, and the parity blocks are assumed to be based on RV1 to RV4, then a different parity bit is transmitted depending on the value of RV.

In the frame generated by the physical layer frame generator 10003a-1, the control information may be included in the header (PHY header or MAC-header) added to the data frame, or the control information may be separately transmitted as a control frame. The control information includes information indicating to which RU the data addressed to each radio communication apparatus is mapped (here, the RU including both frequency resources and spatial resources). The control information may include information related to error correction coding. Specifically, there is a data block identifier (information block identifier) for identifying a data block before encoding (corresponding to an information block, an LDPC information block in the case of LDPC encoding described later), and for example, the same data block identifier is added to a coded block (corresponding to a codeword block, an LDPC codeword block in the case of LDPC encoding described later) generated from one data block. That is, if multiple coded blocks generated according to the above-described RV values are generated from the same data block, the same data block identifier is added, and if the coded blocks are generated from different data blocks, different data block identifiers are added. Basically, although a different data block identifier is assigned to each data block, multiple data blocks may be regarded as a data block group and the same data block identifier may be assigned. Note that the data block group may be a unit for determining ACK (or block ACK). Furthermore, the data block identifier may be a sequence number in the MAC header, a value associated with the sequence number, or a value calculated based on the Sequence Number. In a case that the number of coded blocks combining (HARQ combining) that can be performed at the same time is limited due to limitations of hardware or the like, the number of valid data block identifiers may be limited. The upper and lower limits of the range of valid data identifiers may vary, and the number of digits that an identifier can use may be limited.

In this way, it is possible to distinguish whether the radio frame includes a codeword block (or a codeword block group) generated from the same data block or a codeword block (or a codeword block group) generated from different data blocks with the data block identifier included in the control information. The allocation of data block identifiers can be similarly applied to a case that aggregation such as A-MPDU or A-MSDU is performed. The information about error correction coding included in the control information also includes an RV value, an MCS, a modulation scheme, the number of retransmission operations, an initial transmission identifier, and the like. An initial transmission identifier is an identifier indicating whether a data block (or a data block group) is initially transmitted (new data).

The frame generated by the physical layer frame generator 10003a-1 also includes a trigger frame for indicating, to the radio communication apparatus that is a destination terminal, frame transmission. The trigger frame includes information indicating the RU to be used by the radio communication apparatus that has received the indication for the frame transmission to transmit the frame.

The radio transmitter 10003b-1 converts the physical layer frame generated by the physical layer frame generator 10003a-1 into a signal in a radio frequency (RF) band to generate a radio frequency signal. Processing performed by the radio transmitter 10003b-1 includes digital-to-analog conversion, filtering, frequency conversion from a baseband to an RF band, and the like.

The receiver 10004-1 includes a radio receiver (radio reception step) 10004a-1 and a signal demodulator (signal demodulation step) 10004b-1. The receiver 10004-1 generates information about received signal power from a signal in the RF band received by the antenna unit 10005-1. The receiver 10004-1 can signal the information about the received signal power and the information about the received signal to the CCA unit 10002a-1.

The radio receiver 10004a-1 has a function of converting a signal in the RF band received by the antenna unit 10005-1 into a baseband signal and generating a physical layer signal (e.g., a physical layer frame). Processing performed by the radio receiver 10004a-1 includes frequency conversion processing from the RF band to the baseband, filtering, and analog-to-digital conversion.

The signal demodulator 10004b-1 has a function of demodulating a physical layer signal generated by the radio receiver 10004a-1. Processing performed by the signal demodulator 10004b-1 includes channel equalization, demapping, error correction decoding, and the like. The signal demodulator 10004b-1 can extract, from the physical layer signal, information included in the PHY header, information included in the MAC header, and information included in the transmission frame, for example. The signal demodulator 10004b-1 can signal the extracted information to the higher layer unit 10001-1. Note that the signal demodulator 10004b-1 can extract any one or all of the information included in the PHY header, the information included in the MAC header, and the information included in the transmission frame.

The antenna unit 10005-1 has a function of transmitting a radio frequency signal generated by the radio transmitter 10003b-1 to a radio space. In addition, the antenna unit 10005-1 has a function of receiving a radio frequency signal and passing the radio frequency signal to the radio receiver 10004a-1.

The radio communication apparatus 10-1 can cause radio communication apparatuses in the surroundings of the radio communication apparatus 10-1 to configure a NAV corresponding to a period during which the radio communication apparatus uses a radio medium by describing information indicating the period in the PHY header or the MAC header of the frame to be transmitted. For example, the radio communication apparatus 10-1 can describe the information indicating the period in a Duration/ID field or a Length field of the frame to be transmitted. The NAV period configured to the radio communication apparatuses in the surroundings of the radio communication apparatus will be referred to as a TXOP duration (or simply TXOP) acquired by the radio communication apparatus 10-1. In addition, the radio communication apparatus 10-1 that has acquired the TXOP will be referred to as a TXOP acquirer (TXOP holder). The type of frame to be transmitted by the radio communication apparatus 10-1 to acquire a TXOP is not limited to any frame type, and the frame may be a control frame (e.g., an RTS frame or a CTS-to-self frame) or may be a data frame.

The radio communication apparatus 10-1 that is a TXOP holder can transmit the frame to radio communication apparatuses other than the radio communication apparatus itself during the TXOP. In a case that the radio communication apparatus 1-1 is a TXOP holder, the radio communication apparatus 1-1 can transmit a frame to the radio communication apparatus 2A during the TXOP period. The radio communication apparatus 1-1 can also indicate, to the radio communication apparatus 2A, frame transmission addressed to the radio communication apparatus 1-1 during the TXOP period. The radio communication apparatus 1-1 can transmit, to the radio communication apparatus 2A, a trigger frame including the information indicating frame transmission addressed to the radio communication apparatus 1-1 during the TXOP period.

The radio communication apparatus 1-1 may acquire a TXOP for the entire communication band (e.g., Operation bandwidth) in which frame transmission is likely to be performed, or may acquire a TXOP for a specific communication band (Band) such as a communication band in which frames are actually transmitted (e.g., Transmission bandwidth).

The radio communication apparatus that provides an indication for transmitting a frame in the TXOP duration acquired by the radio communication apparatus 1-1 is not necessarily limited to radio communication apparatuses associated to the radio communication apparatus itself. For example, the radio communication apparatus can provide an indication for transmitting a frame to radio communication apparatuses that are not associated to the radio communication apparatus itself in order to cause the radio communication apparatuses in the surroundings of the radio communication apparatus to transmit a management frame such as a Reassociation frame or a control frame such as an RTS/CTS frame.

Furthermore, a TXOP in EDCA that is a data transmission method different from the DCF will also be described. The IEEE 802.11e standard relates to the EDCA, and prescribes the TXOP from the perspective of Quality of Service (QoS) assurance for various services such as video transmission or VoIP. The services are roughly classified into four access categories, namely VOice (VO), VIdeo (VI), BestEffort (BE), and BacK ground (BK). In general, the order of priority is VO, VI, BE, and BK. Each of the access categories has parameters including CWmin as a minimum value of CW, CWmax as a maximum value, Arbitration IFS (AIFS) as a type of IFS, and TXOP limit as an upper limit value of the transmission opportunity, which are configured to give a difference in the priority. For example, it is possible to perform data transmission prioritized over the other access categories by setting CWmin, CWmax, and AIFS of VO with the highest priority for the purpose of voice transmission equal to a relatively small value as compared with the other access categories. For example, for the VI, where the amount of transmission data is relatively large due to video transmission, the TXOP limit can be configured to be larger, so that the transmission opportunity can be longer than the other access categories. In this manner, four parameter values of each of the access categories are adjusted for the purpose of QoS assurance in accordance with various services.

Although a case that the radio communication apparatus 1-1 (the base station apparatus 1-1) performs transmission and the radio communication apparatus 2-1 (the terminal apparatus 2-1) performs reception will be described in the embodiments described below, the present invention is not limited to this and includes a case that the radio communication apparatus 2-1 (the terminal apparatus 2-1) performs transmission and the radio communication apparatus 1-1 (the base station apparatus 1-1) performs reception. Note that the apparatus configurations of the radio communication apparatus 1-1 and the radio communication apparatus 2-1 are similar to the apparatus configuration example described using FIGS. 6 and 7 unless particularly indicated otherwise.

The higher layer unit 10001-1 of the radio communication apparatus 1-1 according to the present embodiment transfers, to the transmitter 10003-1, A-MPDU which corresponds to a payload of the MAC layer in which one MPDU or two or more MPDUs are aggregated from the information bit sequence transferred to the MAC layer. The higher layer unit 10001-1 also transfers the control information including the configuration of the retransmission scheme to the transmitter 10003-1. The configuration of the retransmission scheme is, for example, information indicating one of an ARQ or a HARQ, or configuration information of a HARQ. The configuration information of a HARQ is information indicating whether a HARQ is configured. Note that, in a case that no HARQ is configured, the PHY layer determines that an ARQ is configured. In a case that the information bit sequence includes one MPDU, the configuration of the MPDU, the MPDU length, and the retransmission scheme is transferred to the transmitter in the lower layer. On the other hand, in the case that the information bit sequence includes A-MPDU, the A-MPDU and the A-MPDU length are transferred to the transmitter in the lower layer in a case that the configuration of the retransmission scheme indicates an ARQ. In a case that the configuration of the retransmission scheme indicates a HARQ, some or all of the A-MPDU, the A-MPDU length, each MPDU length, and the number of MPDUs are transferred to the transmitter in the lower layer. The MPDU may constitute an A-MSDU in which one MSDU or two or more MSDUs are aggregated. Note that in a case that the retransmission scheme is not indicated in the HARQ, the control information of the MAC layer of the higher layer unit 10001-1 does not necessarily add an information field for storing the MPDU length and the number of MPDUs.

The physical layer frame generator 10003a-1 of the radio communication apparatus 1-1 according to the present embodiment first generates a PSDU corresponding to the payload of the PHY layer, from the A-MPDU transferred by the higher layer unit 10001-1. A PHY header is added to the PSDU to generate a PPDU of the transmission frame. The PHY header includes a PLCP preamble for synchronization detection, a PLCP header for determining a Modulation and Coding Scheme in accordance with a received signal strength, control information signaled by the MAC layer of the higher layer unit 10001-1, and an information field of a prescribed information bit length (coded block length) to be subjected to error correction coding corresponding to each information field in a case that an information field for the MPDU length is added to the control information. Note that, in a case that the MAC layer of the higher layer unit 10001-1 does not configure aggregation of MPDUs, the PHY header may store the prescribed information bit length in the information field.

For example, in error correction coding using a Low Density Parity Check (LDPC) of the IEEE 802.11 standard, a generator matrix is first obtained from a low-density parity check matrix, and parity bits that are calculated from a matrix product of the generator matrix and information bits are generated. Next, the parity bit is added to the information bit sequence to form a codeword. Specifically, the physical layer frame generator 10003a-1 and the coder 10003c-1 calculate a prescribed information bit length to be subjected to error correction coding based on the size of the parity check matrix configured with the coding rate of the MCS. Note that an information bit sequence used for LDPC coding is also referred to as an LDPC information block, and a bit sequence obtained by LDPC-coding an LDPC information block is also referred to as an LDPC codeword block. An information block identifier is an identifier for identifying each LDPC information block, and the same information block identifier is assigned to LDPC codeword blocks generated from the same information block. That is, if multiple LDPC codeword blocks generated according to the above-described RV values are generated from the same LDPC information block, the same information block identifier is assigned. The information block identifier may be stored in the header as one piece of control information, and information about RV values may also be stored in the header. Note that, although a different information block identifier is assigned to each LDPC information block basically, multiple LDPC information blocks may be regarded as a data block group and the same information block identifier may be assigned. As will be described below, although multiple LDPC information blocks may be generated from PSDUs, and the PSDUs may be regarded as a data block group and the same information block identifier may be assigned.

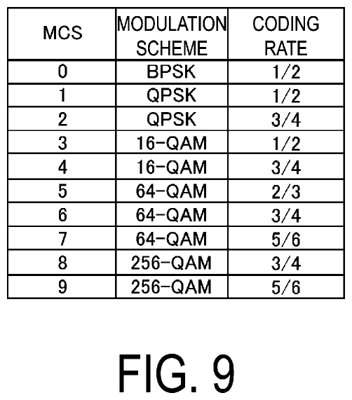

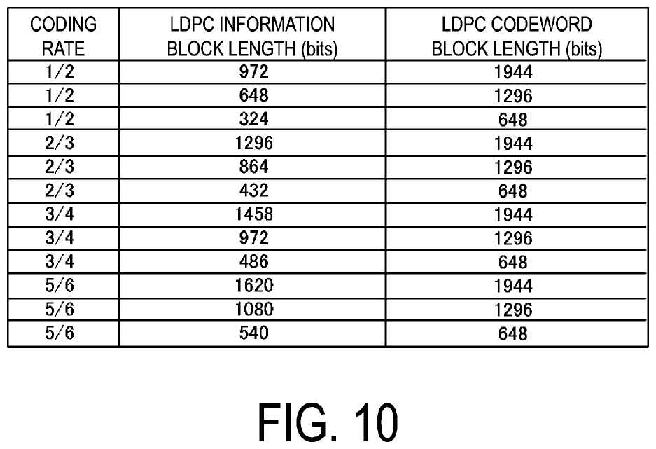

FIG. 9 illustrates an example of association between MCSs, modulation schemes and coding rates. For example, in a case that an MCS is 1, the modulation scheme is QPSK and the coding rate is 1/2, and in a case that an MCS is 4, the modulation scheme is 16QAM and the coding rate is 3/4. In addition, FIG. 10 illustrates an example of association between coding rates, LDPC information block lengths and LDPC codeword block lengths. In a case that an LDPC codeword block length is multiplied by a coding rate, the result is an LDPC information block length. For example, in a case that the coding rate is 1/2, candidates for (LDPC information block length, LDPC codeword block length) are (972, 1944), (648, 1296), and (324, 648). Note that the LDPC information block lengths and the LDPC codeword block lengths are values determined by parity check matrix sizes, and may be different from transmitted information block lengths and codeword block lengths.

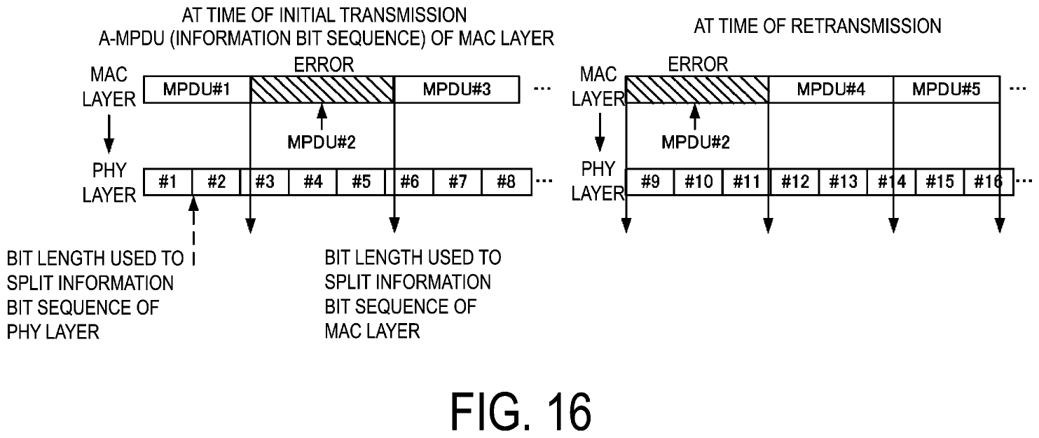

FIG. 16 is a schematic diagram illustrating an example of blocking processing performed by the physical layer frame generator 10003a-1 (including the coder 10003c-1) in a case that the configuration of the retransmission scheme indicates an ARQ. The physical layer frame generator 10003a-1 generates a transmission frame by dividing the PSDUs into multiple information blocks at the prescribed information bit length determined by the MCS included in the PHY header, and performing error correction coding on each information block. Note that an information block subjected to error correction coding is also referred to as a codeword block (or a coded block). In the blocking processing in the figure, the prescribed bit length used by the MAC layer to split the information bit sequence into PSDUs may not match the array of multiple prescribed bit lengths used by the PHY layer to split the information bit sequence into PSDUs. In other words, the physical layer frame generator 10003a-1 allows each information block to include two or more MPDUs. Each of block #3 and block #6 in FIG. 16 includes two or more MPDUs, and the former stores a part of the information bit sequence included in MPDUs #1 and #2 and the latter stores a part of the information bit sequence included in MPDUs #2 and #3. Note that, in this example, the MAC layer of the higher layer unit 10001-1 having received the Block Ack in the transmission frame retransmits MPDU #2 because an error has been detected in MPDU #2. In a case that MPDU #2 is retransmitted, the PHY layer transmits the PSDU after blocking, however, in a case that a block of the PHY layer includes multiple MPDUs, the PHY layer may be divided into blocks, unlike in the initial transmission, and in this case, different codeword blocks are transmitted. In this case, the reception side fails to combine the initially transmitted MPDU #2 and the retransmitted MPDU #2.

An example of a procedure in which the physical layer frame generator 10003a-1 divides a PSDU (A-MPDU) into information blocks in a case that the configuration of the retransmission scheme indicates an ARQ will be described. The LDPC codeword block length is determined by a coded bit length (also referred to as a first coded bit length) calculated based on at least the PSDU length (A-MPDU length) and the coding rate. For example, in the example of FIG. 10, in a case that the first coded bit length is 648 bits or less, the LDPC codeword block length (L_{CW}) is 648 bits. Next, in a case that the first coded bit length is greater than 648 bits and 1296 bits or less, the LDPC codeword block length is 1296 bits. In addition, in a case that the first coded bit length is greater than 1296 bits and 1944 bits or less, the LDPC codeword block length is 1944 bits. Note that, in a case that the first coded bit length is 1944 bits or less, the number of LDPC codeword blocks (N_{CW}) is 1. In a case that the first coded bit length is greater than 1944 bits and 2592 bits or less, the LDPC codeword block length is 1296 bits and the number of LDPC codeword blocks is 2. In a case that the LDPC codeword block length is greater than 2592 bits, the LDPC codeword block length is 1944 bits, and the number of LDPC codeword blocks can be calculated as ceil (first coded bit length/1944) from the first coded bit length and 1944 bits corresponding to the LDPC codeword block length. Note that ceil (x) is a ceiling function and represents the minimum integer equal to or greater than x.

In a case that N_{CW}*L_{CW}*R is different from a PSDU length, shortening processing is performed. Note that R represents a coding rate. The difference between N_{CW}*L_{CW}*R and a PSDU length is denoted by Nₛₕᵣₜ. Nₛₕᵣₜ is equally distributed to each of information blocks. In other words, a shortening bit N_{shblk} of each information block is floor (Nₛₕᵣₜ/N_{CW}). However, floor (x) is a floor function and represents the maximum integer less than or equal to x. Note that the first Nₛₕᵣₜ mod N_{CW} block includes one more shortening bit than the other blocks. However, mod represents a remainder. In the shortening process, N_{shblk} bits (or N_{shblk}+1) bits are added to the information block to generate an LDPC information block. Accordingly, the PSDU is divided into information blocks in consideration of the shortening processing. Although the LDPC information block is LDPC-coded to generate an LDPC codeword block, the shortening bits are discarded.

In a case that N_{CW}*L_{CW} and (first coded bit length+Nₛₕᵣₜ) are different from each other, puncturing processing is performed to discard (decimate) parity bits. The difference between N_{CW}*L_{CW} and (first coded bit length+Nₛₕᵣₜ) is represented by N_{punc}. N_{punc} is equally distributed to each of codeword blocks. In other words, a puncturing bit N_{pcblk} of each codeword block is floor (N_{punc}/N_{CW}). Note that the first N_{punc} mod N_{CW} block includes one more puncturing bit than the other blocks. In the puncturing processing, the last N_{pcblk} (or N_{pcblk}+1) bits of the LDPC codeword block are discarded. The shortening processing and the puncturing processing generate a codeword block to be transmitted.

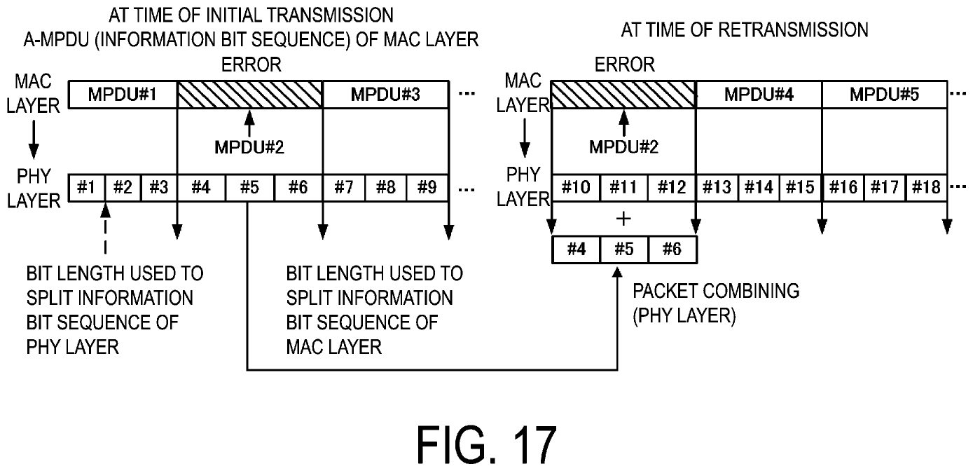

FIG. 17 is a schematic diagram illustrating an example of blocking processing performed by the physical layer frame generator 10003a-1 (including the coder 10003c-1) in a case that the control information of the MAC layer includes the information field of the MPDU length (in a case that the configuration of the retransmission scheme indicates a HARQ). The physical layer frame generator 10003a-1 divides each of MPDUs forming a PSDU into multiple information blocks based on the MPDU length of the control information in addition to a prescribed information bit length determined by the MCS included in the PHY header. In addition, the physical layer frame generator 10003a-1 calculates the information block length and stores the information block length in the information field of the same header. In a case that an integer multiple of the information block length is the MPDU length, the number of information blocks may be stored in the PHY header. Subsequently, each information block is subjected to error correction coding to generate a transmission frame. In the blocking processing in the figure, one MPDU includes one or more information blocks. In other words, the physical layer frame generator 10003a-1 is not allowed to include two or more MPDUs in each block. Each of blocks #4 to #6 in the figure stores an information bit sequence of MPDU #2. Note that, in this example, the MAC layer of the higher layer unit 10001-1 having received the Block Ack in the transmission frame retransmits MPDU #2 because an error has been detected in MPDU #2. Since each MPDU is divided into information blocks, the same codeword block as that used in the initial transmission can be transmitted in retransmission. In this case, the reception side can combine the initially transmitted MPDU #2 with the retransmitted MPDU #2 to enable reception quality to be improved.

In a case that the control information of the MAC layer includes the information field of the MPDU length (an example of a case that a configuration of the retransmission scheme indicates a HARQ), the LDPC codeword block length is determined with a coded bit length (also referred to as a second coded bit length) calculated based on at least the MPDU length and the coding rate. Note that, in a case that the MPDU length varies for each MPDU, the second coded bit length is calculated for each MPDU. For example, in a case that the second coded bit length is 648 bits or less, the LDPC codeword block length is 648 bits. In addition, in a case that the second coded bit length is greater than 648 bits and 1296 bits or less, the LDPC codeword block length is 1296 bits. In addition, in a case that the second coded bit length is greater than 1296 bits and 1944 bits or less, the LDPC codeword block length is 1944 bits. Note that, in a case that the second coded bit length is 1944 bits or less, the number of LDPC codeword blocks is 1. In a case that the second coded bit length is greater than 1944 bits and 2592 bits or less, the LDPC codeword block length is 1296 bits and the number of LDPC codeword blocks is 2. In a case that the LDPC codeword block length is greater than 2592 bits, the LDPC codeword block length is 1944 bits, and the number of LDPC codeword blocks can be calculated as ceil (second coded bit length/1944) from the second coded bit length and 1944 bits corresponding to the LDPC codeword block length.

In a case that the control information of the MAC layer includes the information field of the MPDU length (an example of the case that the configuration of the retransmission scheme indicates a HARQ), shortening processing is performed for each MPDU. In a case that N_{CW}*L_{CW}*R is different from the MPDU length, the shortening processing is performed. The difference between N_{CW}*L_{CW}*R and the MPDU length is represented by Nₛₕᵣₜ. Nₛₕᵣₜ is equally distributed to each of the information blocks. In other words, a shortening bit N_{shblk} of each information block is floor (Nₛₕᵣₜ/N_{CW}). Note that the first Nₛₕᵣₜ mod N_{CW} block includes one more shortening bit than the other blocks. However, mod represents a remainder. In the shortening process, N_{shblk} (or N_{shblk}+1) bits are added to the information block to generate an LDPC information block. Accordingly, the PSDU is divided into information blocks in consideration of the shortening processing. Although the LDPC information block is LDPC-coded to generate an LDPC codeword block, the shortening bits are discarded.

In a case that the control information of the MAC layer includes the information field of the MPDU length (an example of the case that the configuration of the retransmission scheme indicates a HARQ), puncturing processing is performed for each MPDU. In a case that N_{CW}*L_{CW} is different from (second coded bit length+Nₛₕᵣₜ), the puncturing processing is performed. The difference between N_{CW}*L_{CW} and (second coded bit length+Nₛₕᵣₜ) is represented by N_{punc}. N_{punc} is equally distributed to each of codeword blocks. In other words, a puncturing bit N_{pcblk} of each codeword block is floor (N_{punc}/N_{CW}). Note that the first N_{punc} mod N_{CW} block includes one more puncturing bit than the other blocks. In the puncturing processing, the last N_{pcblk} (or N_{pcblk}+1) bits of the LDPC codeword block are discarded. The shortening processing and the puncturing processing generate a codeword block to be transmitted.

On the other hand, in a case that the control information of the MAC layer includes the information field of the MPDU length (an example of the case that the configuration of the retransmission scheme indicates a HARQ), the physical layer frame generator 10003a-1 according to the present embodiment can perform blocking processing on the PSDU at the coded block length with reference to a table or a calculation formula that enables the coded block length to be calculated according to the MCS and the MPDU length.

Note that the coding method according to the present embodiment is not limited to LDPC. For example, a transmission apparatus according to the present embodiment can also use a Binary Convolutional Code (BCC). At this time, the transmission apparatus can use BCC to perform the blocking processing method described above, that is, the blocking processing performed in a case that an ARQ is configured and the blocking processing performed in a case that a HARQ is configured. For example, in a case that a HARQ is configured, the transmission apparatus can match the number of information bits included in an information block with the number of bits included in a MPDU. In addition, the transmission apparatus can match an integer multiple of the number of information bits included in the information block with the number of bits included in the MPDU.

In addition, the transmission apparatus according to the present embodiment band can switch the blocking processing by using the error correction coding method configured in the PHY layer. For example, in a case that BCC is configured as the error correction coding method, the transmission apparatus can perform the blocking processing assuming an ARQ, and in a case that LDPC is configured, the transmission apparatus can perform blocking processing assuming a HARQ. In addition, in a case that BCC is configured, the transmission apparatus may perform the blocking processing assuming a HARQ, and in a case that LDPC is configured, the transmission apparatus may perform the blocking processing assuming an ARQ.

The table or the calculation formula may include multiple candidate values for the MPDU length for each maximum MPDU size (e.g., 3895, 7991, 11454 bytes for 11ac), and may store candidate values for a prescribed information bit length to be coded for each MCS in each of the MPDU lengths. For example, in a case that a certain MPDU length forming an A-MPDU transferred from the higher layer unit 10001-1 according to the present embodiment is 3895 bytes or less, the transmitter can refer to the table or the calculation formula to select a candidate value that is equal to the MPDU length of the MPDU or a candidate value that is closest to the MPDU length, and can sequentially acquire candidate values of the coded block length as indexes according to the MCS. Note that, the station apparatus, the access point, and the like according to the present embodiment can update the table or the calculation formula with a management frame such as a beacon frame, and can share the index of the coded block length.

In the blocking processing using the table and the calculation formula, the PHY header included in the transmission frame includes a PLCP preamble for performing synchronization detection, a PLCP header for determining the modulation and coding scheme (MCS) corresponding to a received signal strength, control information for signaling an ARQ/HARQ in the MAC layer of the higher layer unit 10001-1, and the index enabling the coded block length to be referred to.

Note that, in a case that the control information of the MAC layer includes the information field of the MPDU length (an example of the case that the configuration of the retransmission scheme indicates a HARQ), the MPDU length and/or the MCS can be limited to prevent one information block from including the bits of multiple MPDUs. For example, the MPDU length is limited to an integer multiple of the LDPC information block length corresponding to an LDPC codeword block length of 1944 bits, and use of a MCS other than MCSs with the coding rate corresponding to an LDPC block length that is a divisor of the MPDU is limited. For example, in a case that multiple MPDUs of 1458 bytes are aggregated to form a PSDU, since the MPDU length is divided by LDPC information blocks corresponding to coding rates of 1/2, 2/3, and 3/4, the result does not change regardless of whether the PSDU is subjected to the blocking processing or subjected to the blocking processing for each MPDU. Accordingly, in a case that the configuration of the retransmission scheme indicates a HARQ and the MPDU length is 1458 bytes, by avoiding use of MCS7 and MCS9 with a coding rate of 5/6 corresponding to LDPC information block length by which the MPDU length is indivisible, codeword block combining can be performed on the reception side even in a case that the PSDU is subjected to the blocking processing as in the case that the configuration of the retransmission scheme indicates an ARQ. In addition, even in a case that the configuration of the retransmission scheme indicates a HARQ, it may mean an ARQ in a case that a limited MCS is used. For example, in a case that MCS7 is applied to an MPDU length of 1458 bytes, the retransmission scheme may indicate an ARQ. In this case, even in a case that the configuration of the retransmission scheme indicates a HARQ, the radio communication apparatus 1-1 performs the blocking processing on the PSDU and transmits the resulting PSDU.

The radio communication apparatus 1-1 according to the present embodiment indicates, as the ARQ/HARQ, the retransmission scheme included in the control information signaled by the MAC layer of the higher layer unit 10001-1, to determine whether to add the control information with the information field of the MPDU length forming the A-MPDU or allow to switch between the blocking processing on the PSDU and the blocking processing on the MPDU according to the control information.

In the radio communication system according to the present embodiment, it is possible to divide an available radio channel (a radio communication channel, or a system bandwidth) into multiple sub-channels, allocate a redundant codeword block or codeword block group (coded block or coded block group) to each sub-channel, and perform transmission at the same timing. Here, the redundant codeword block refers to multiple coding results of the same information block. The redundant codeword block group refers to multiple coding results of the same information block group. Note that each of codeword blocks starting from RV1, RV2, RV3, and RV4 described above with reference to FIG. 8 have a redundant relationship with each other. In the following description, a codeword block starting from RV1 will be referred to as RV1, a codeword block starting from RV2 will be referred to as RV2, a codeword block starting from RV3 will be referred to as RV3, and a codeword block starting from RV4 will be referred to as RV4.

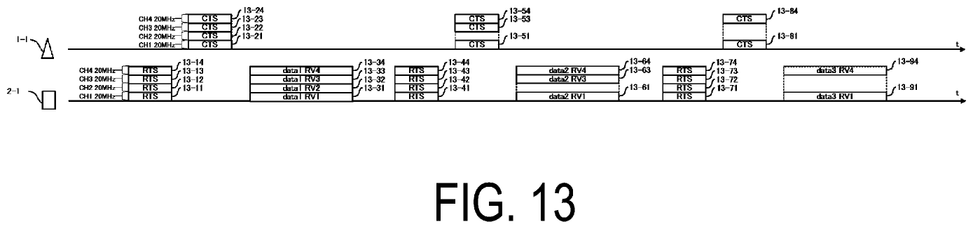

The allocation of the codeword blocks (RV1, RV2, RV3, and RV4) to the sub-channels (CH1, CH2, CH3, and CH4) and the transmission method will be described with reference to FIG. 13. Description will be provided in FIG. 13 on the assumption that the system bandwidth is 80 MHz, and redundant codeword blocks corresponding to RV1 to RV4 are respectively allocated to CH1 to CH4 of 20 MHz bandwidth corresponding to Preamble puncturing Resolution in each sub-channel. In practice, the system bandwidth may be any value prescribed in the IEEE standard (160 MHz, 320 MHz, etc.). The bandwidth of each sub-channel may also be a value (e.g., 10 MHz or 5 MHz) less than the Preamble puncturing Resolution or may be a value (e.g., 40 MHz) greater than the Preamble puncturing Resolution. Furthermore, it is not limited to a codeword block to be allocated to each sub-channel, but a codeword block group may be allocated. Note that response frames (Ack, Block Ack, etc.) are not illustrated in FIG. 13.

Implicitly, the codeword blocks corresponding to RV1, RV2, RV3, and RV4 may be allocated to the sub-channels CH1, CH2, CH3, and CH4, but the allocation is not limited thereto, and for example, the codeword blocks may be allocated in the order of CH4, CH3, CH2, and CH1. In addition, the allocation combination of RVs to sub-channels may be determined not implicitly but by control information included in the header.

One codeword block, for example, a codeword block corresponding to RV1, may be transmitted on multiple sub-channels. As a specific example, RV1 may be transmitted on two sub-channels of CH1 and CH2. Which sub-channel transmits a codeword block corresponding to which RV may be implicitly determined, or the allocation combination of RVs to sub-channels may be determined by control information included in the header.

Note that the allocation combination of RVs to sub-channels may be selected from several candidates. For example, examples of candidates for RV to be allocated to a sub-channel (CH1, CH2, CH3, or CH4) may be (RV1, RV2, RV3, RV4), (RV1, RV1, RV3, RV3), or (RV1, RV1, RV1, RV1).

The frame generator allocates (maps) the codeword blocks generated by the coder to the sub-channels. In this example, it is prepared to transmit a codeword block corresponding to RV1 on CH1, a codeword block corresponding to RV2 on CH2, a codeword block corresponding to RV3 on CH3, and a codeword block corresponding to RV4 on CH4 to prepare for transmission of four frames corresponding to the number of the number of sub-channels. In addition, in each frame, an information block identifier is added to the control information or the header. If the original information blocks are the same, the same information block identifier is assigned thereto, and “data1” is used in this description, but the identifier is not limited to a character string and may be a numeric string as long as it helps ascertain that the information blocks are the same.

In a case that carrier sensing is performed on the CH1 after waiting for a random backoff time to determine that the radio channel is in the idle state, the station apparatus 2-1 transmits an RTS frame 13-11 on the CH1 and transmits equivalent frames as RTS frames 13-12 to 13-14 to the CH2 to the CH4 at the same timing. In a case that the access point apparatus 1-1 having received the RTS frames checks the radio channel conditions of the CH1 to the CH4 to determine that the radio channel conditions are the idle states, the access point apparatus 1-1 transmits CTS frames 13-21 to 13-24 indicating the idle states to the CH1 to the CH4, respectively, and the station apparatus 2-1 receives the CTS frames. The station apparatus determines that the radio channels the CH1 to the CH4 are available, and transmits the data frames 12-31 to 12-34 with the same information block identifier assigned. That is, the entire channel bandwidth 80 MHz can be used for transmission of data frames.

The access point apparatus 1-1 receives the data frames 13-31 to 13-34 and performs decoding processing in the signal demodulator. In a case that at least one of the data frames 13-31 to 13-34 can be decoded without error, a response frame indicating that the data frames have been correctly received is transmitted to the station apparatus 2-1. In a case that an error has been detected in all of the data frames 13-31 to 13-34, the access point apparatus 1-1 refers to the header of each data frame and checks the data block identifier included in the control information. Frames having the same data block identifier are determined to be frames including codeword blocks having a redundant relationship with each other, and combining of the target codeword blocks is attempted. In a case that the data block identifiers of the respective frames are different from each other, it is determined that a codeword block in a redundant relationship is not included, decoding processing is ended, and a response frame is not transmitted to the station apparatus 2-1 or a response frame (Ack, Block Ack, etc.) indicating error detection is transmitted. In the case of this example, since the same data block identifier is assigned to the data frames 13-31 to 13-34, combining of the corresponding codeword blocks is attempted, and in a case that the codeword blocks can be correctly decoded, a response frame indicating the correct decoding is transmitted to the station apparatus 2-1. In a case that the codeword blocks cannot be correctly decoded even though the combining of the codeword blocks was attempted, no response frame is transmitted to the station apparatus 2-1 or a response frame (Ack, Block Ack, etc.) indicating error detection is transmitted.

As another example, there is a case that CTS frames are received on the CH1 which is the primary channel but no CTS frames can be received on all of the CH1 to the CH4. For example, that is a case that the access point apparatus 1-1 having received the RTS frames 13-41 to 13-44 on the CH1 to the CH4, respectively, checks the radio channel conditions to determine that the CH1, CH3, and CH4 are in the idle state, and transmits the CTS frames (13-51, 13-53, and 13-54) on the CH1, CH3, and CH4. Since the station apparatus 2-1 has received the CTS frames on the CH1 that is the primary channel, the station apparatus 2-1 is able to transmit data frames, and is also able to transmit the frames on the CH3 and CH4 in the idle state by using the Preamble puncturing mechanism. In this example, the frame 13-61 corresponding to RV1 is transmitted on the CH1, 13-63 corresponding to RV3 is transmitted on the CH3, and 13-64 corresponding to RV4 is transmitted on the CH4. If the original information blocks are the same, the same information block identifier is assigned thereto, and “data2” is used in this description, but the identifier is not limited to a character string and may be a numeric string as long as it helps ascertain that the information blocks are the same. On the other hand, the frame corresponding to the RV2 scheduled to be transmitted on the CH2 is not transmitted. Combining of sub-channels and redundant coded blocks are not limited to the combining described above. It is only required to transmit coded blocks having a redundant relationship with each other in a sub-channel in an idle state.

The access point apparatus 1-1 receives the data frames 13-61, 13-63, and 13-64 and performs decoding processing in the signal demodulator. In a case that at least one of the data frames can be decoded without error, a response frame indicating that the data frames have been correctly received is transmitted to the station apparatus 2-1. In a case that an error has been detected in all of the data frames 13-61, 13-63, and 13-64, the access point apparatus 1-1 refers to the header of each data frame and checks the data block identifier included in the control information. Frames having the same data block identifier are determined to be frames including codeword blocks having a redundant relationship with each other, and combining of the target codeword blocks is attempted. In a case that the data block identifiers of the respective frames are different from each other, it is determined that a codeword block in a redundant relationship is not included, decoding processing is ended, and a response frame is not transmitted to the station apparatus 2-1 or a response frame (Ack, Block Ack, etc.) indicating error detection is transmitted. In the case of this example, since the same data block identifier is assigned to the data frames 13-61, 13-63, and 13-64, combining of the corresponding codeword blocks is attempted, and in a case that the codeword blocks can be correctly decoded, a response frame indicating the correct decoding is transmitted to the station apparatus 2-1. In a case that the codeword blocks cannot be correctly decoded even though the combining of the codeword blocks of the frames was attempted, no response frame is transmitted to the station apparatus 2-1 or a response frame (Ack, Block Ack, etc.) indicating error detection is transmitted.

Similarly, FIG. 13 also illustrates an example in which data frame are transmitted on the CH1 and CH4 by the Preamble puncturing mechanism in a case that the CH1 and CH4 are in the idle state. RTS frames are 13-71 to 13-74, CTS frames are 13-81 and 13-84, and data frames are 13-91 and 13-94.

Note that, the modulation and coding schemes for frames to be transmitted on each sub-channel need not be the same. It is also possible to apply different modulation and coding schemes to each sub-channel such that a frame transmitted on a certain sub-channel is modulated and encoded in a high modulation scheme and a high coding scheme, and a frame transmitted on another sub-channel is modulated and encoded in a low modulation scheme and a low coding scheme. If the access point apparatus side can normally decode a frame that has been received on a certain sub-channel and subjected to a high modulation scheme and a high coding scheme independently, lower-latency communication can be realized. In a case that individual decoding of a frame that has been received on a certain sub-channel and subjected to a high modulation scheme and a high coding scheme is erroneous, it is combined with a coded block included in a frame received on another sub-channel, and thereby reliability and robustness can be improved. Note that a RV and a modulation and coding scheme may be associated with each other. For example, the modulation scheme and/or coding rate of RV2 may be lower than that of RV1. In this case, the number of bits transmitted in RV2 is fewer than that of RV1.

As a supplement, strictly, frames are not constituted in units of sub-channels in the related art. For example, in FIG. 12, although the frame 12-31 is in the 80 MHz bandwidth, one coded block is allocated (mapped) in the entire 80 MHz bandwidth to form a frame, and separate frames are not formed in units of sub-channels. Similarly, for the frame 12-81, one coded block is allocated (mapped) in the total of 60 MHz bandwidth of the CH1, CH3, and CH4 to form a frame. In the present invention, by forming a frame in units of sub-channels, compatibility with frame transmission in an environment where a radio medium is crowded and transmission by Preamble puncturing occurs frequently is improved.

As described above, in the present embodiment, the communication apparatus for transmitting a frame forms a frame in units of sub-channels, allocates coded blocks having a redundant relationship with each other in each sub-channel, and transmits a frame including coded blocks having a redundant relationship at the same timing only in a sub-channel in which a transmission right can be acquired, even in a case that continuous sub-channels cannot be acquired depending on a channel congestion state. The communication apparatus that receives a frame refers to the header of the frame received on each sub-channel, checks the data block identifier included in the control information, determines whether the frame is to be combined with a coded block, and can obtain a gain by the combining with the coded block when the frame is to be combined. In other words, communication with lower latency and high reliability can be realized.

### 2. Second Embodiment

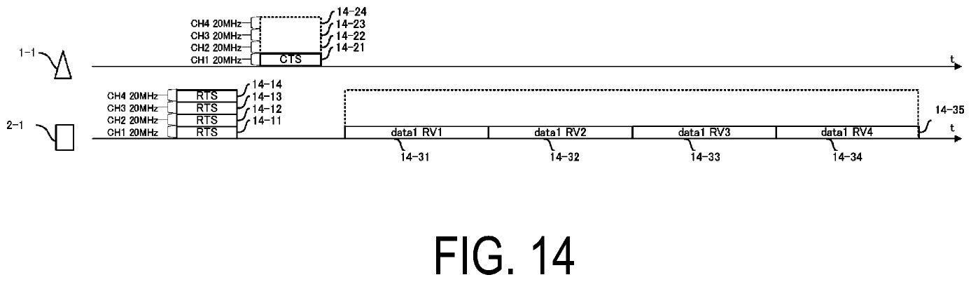

Configurations of a radio communication system, an access point apparatus, and a station apparatus in a second embodiment may be similar to those in the first embodiment. The first embodiment is about a method of allocating coded blocks in a redundant relationship on multiple sub-channels, that is, acquiring diversity in the frequency direction. In the second embodiment, a method of acquiring diversity in the time axis direction will be described with reference to FIG. 14. Note that response frames (Ack, Block Ack, etc.) are not illustrated in FIG. 14.

The frame generator determines to which sub-channel the codeword block generated by the coder is allocated (mapped) in accordance with the state (the idle state or the busy state) of each sub-channel. In this example, frames including codeword blocks corresponding to RV1, RV2, RV3, and RV4 are prepared.

In a case that carrier sensing is performed on the CH1 after waiting for a random backoff time to determine that the radio channel is in the idle state, the station apparatus 2-1 transmits an RTS frame 14-11 on the CH1 and transmits equivalent frames as RTS frames 14-12 to 14-14 to the CH2 to the CH4 at the same timing. The access point apparatus 1-1 having received the RTS frames checks the radio channel conditions of the CH1 to the CH4, and if only the CH1 is in the idle state, the access point apparatus 1-1 transmits a CTS frame 14-21 indicating the idle state to the CH1, and the station apparatus 2-1 receives the CTS frame. The station apparatus determines that only the radio channel of the CH1 is available. In a case that the transmission right of only one sub-channel can be acquire, only one coded block, for example, RV1, or the like can be transmitted in the first embodiment in which coded blocks having redundancy are allocated in the frequency direction, and the redundancy cannot be acquired.

In the second embodiment, coded blocks having a redundant relationship with each other can be arrayed in the time direction and transmitted. The frame generator of the station apparatus receives the notification that only CH1 is in the idle state, stores each of the coded blocks corresponding to RV1, RV2, RV3, and RV4 in each subframe, configures one frame from multiple subframes, and allocates the frame to the CH1. As described above, the control information may be included in the header (the PHY header or the MAC header) added to the data frame, or may be separately transmitted as a control frame. Redundant subframe information is provided in one piece of the control information, and in this example, a numerical value corresponding to the number of subframes and information indicating the RV value of each subframe are stored. For example, when the number of subframes is “4” and the information indicating RV is specified as “RV1”, “RV2”, “RV3”, and “RV4”, it means that one frame includes at least four subframes of RV1, RV2, RV3, and RV4 to be combined with a codeword block. In addition, the information indicating the RV value of a subframe may indicate one of candidates for a RV order. A candidate in the RV order is, for example, (RV1, RV2, RV3, RV4), (RV1, RV3, RV4, RV2), (RV1, RV3, RV1, RV3), or (RV1, RV1, RV1, RV1). Note that, although the examples of the candidate for the RV order show cases of four subframes, in a case that the number of subframes is eight, the RV order of four subframes may be repeated twice. In addition, in a case that the examples of the candidate for the RV order indicates RVs for four subframes and the number of subframes indicated by the redundant subframe information is two, two RVs from the head of the RV order may be indicated.

FIG. 14 shows an example in which one frame includes four subframes including a subframe 14-31 corresponding to RV1, a subframe 14-32 corresponding to RV2, a subframe 14-33 corresponding to RV3, and a subframe 14-34 corresponding to RV4. Redundant subframe information does not need to match the number of coded blocks in a redundant relationship prepared by the frame transmitter. For example, the redundant subframe information may be set to “2” and information indicating a RV value may be only “RV1” and “RV2” to form a frame including only the subframes 14-31 and 14-32, or the information indicating the RV value may be only “RV1” and “RV4” to form a frame including only the subframes 14-31 and 14-34. It is possible to change a combination of the number of subframes and the RV value to be used in accordance with the set value.

The access point apparatus 1-1 receives a data frame 14-35 and performs decoding processing in the signal demodulator. In a case that at least one of the subframes 14-31 to 14-34 can be decoded without error, a response frame indicating that the subframes have been correctly received is transmitted to the station apparatus 2-1. In a case that an error has been detected in all of the subframes 14-31 to 14-34, the access point apparatus 1-1 refers to the header of each data frame and checks the redundant subframe information included in the control information. The RV value of each subframe is ascertained from the redundant subframe information, and combining of codeword blocks having a redundant relationship with each other is attempted. In the case of the example of FIG. 14, since it can be seen that the four subframes 14-31 to 14-34 correspond to RV1, RV2, RV3, and RV4, respectively, combining of the coded blocks is attempted, and in a case that decoding is correctly performed, a response frame indicating the correct decoding is transmitted to the station apparatus 2-1. In a case that the codeword blocks cannot be correctly decoded even though the combining of the coded blocks was attempted, no response frame is transmitted to the station apparatus 2-1 or a response frame (Ack, Block Ack, etc.) indicating error detection is transmitted.

Note that, in the second embodiment, the information block identifier may be included in the control information, and although the value of the information block identifier is set to “data1” in the example of FIG. 14, it may be a character string or a numeric string as long as it is content for identifying the information block. By using the information block identifier in addition to the redundant subframe information, it is possible to include subframes related to multiple information block identifiers in a frame transmitted on one sub-channel.

### 3. Third Embodiment

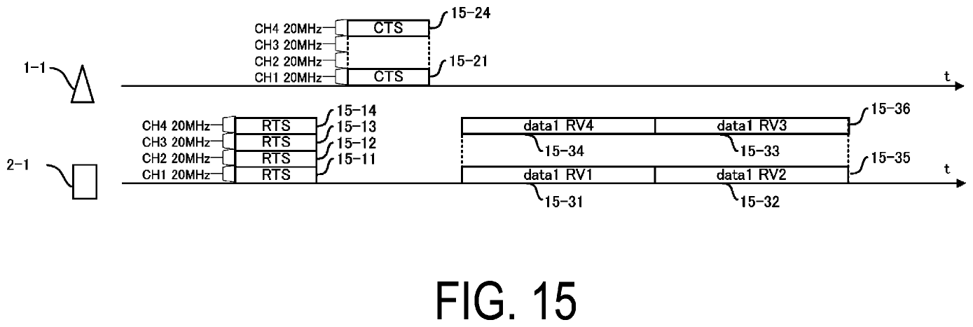

Configurations of a radio communication system, an access point apparatus, and a station apparatus in a third embodiment may be similar to those in the first embodiment. The first embodiment is about a method of allocating coded blocks in a redundant relationship on multiple sub-channels, that is, acquiring diversity in the frequency direction. The second embodiment is about a method of acquiring diversity in the time axis direction. In the third embodiment, a combination of the first and second embodiments, that is, a frame transmission method in which diversity in both the frequency axis direction and the time axis direction is used will be described with reference to FIG. 15. Note that response frames (Ack, Block Ack, etc.) are not illustrated in FIG. 15.

The frame generator determines to which sub-channel the codeword block generated by the coder is allocated (mapped) in accordance with the state (the idle state or the busy state) of each sub-channel. In this example, frames including codeword blocks corresponding to RV1, RV2, RV3, and RV4 are prepared. The control information may be included in the header (the PHY header or the MAC header) added to a data frame, or may be separately transmitted as a control frame. The control information includes an information block identifier and redundant subframe information.

In a case that carrier sensing is performed on the CH1 after waiting for a random backoff time to determine that the radio channel is in the idle state, the station apparatus 2-1 transmits an RTS frame 15-11 on the CH1 and transmits equivalent frames as RTS frames 15-12 to 15-14 to the CH2 to the CH4 at the same timing. The access point apparatus 1-1 having received the RTS frames checks the radio channel conditions of the CH1 to the CH4 to determine that the CH1 and the CH4 are in the idle state, the access point apparatus 1-1 transmits CTS frames 15-21 and 15-24 indicating the idle state to the CH1 and CH4, respectively, and the station apparatus 2-1 receives the CTS frames. The station apparatus determines that the radio channels of the CH1 to the CH4 are available. In this example, a frame 15-35 including a subframe 15-31 in RV1 and a subframe 15-32 in RV2 is transmitted on CH1. “data1” is described as the information block identifier of the frame 15-35, “2” is described as the number of subframes in the redundant subframe information, and “RV1” and “RV2” are described as the information indicating the RV value. A frame 15-36 including a subframe 15-34 in RV4 and a subframe 15-33 in RV3 is transmitted on the CH4. “data1” is described as the information block identifier of the frame 15-36, “2” is described as the number of subframes in the redundant subframe information, and “RV4” and “RV3” are described as the information indicating the RV value. Note that the information block identifier may be a character string or a numeric string as long as it is content for identifying the information block.

The access point apparatus 1-1 receives the data frames 15-35 and 15-36 and performs decoding processing in the signal demodulator. In a case that at least one of the subframes 15-31 to 15-34 can be decoded without error, a response frame indicating that the subframes have been correctly received is transmitted to the station apparatus 2-1. In a case that an error has been detected in all of the data frames 15-31 to 15-34, the access point apparatus 1-1 refers to the header of each data frame and checks the information block identifier and the redundant subframe information included in the control information. Since the information block is “data1” in both the data frames 15-35 and 15-36, it is understood that the data frames 15-35 and 15-36 are to be combined. Furthermore, it is understood from the redundant subframe information that the subframes corresponding to RV1 and RV2 are included in the frame 15-35, and combining of the codeword blocks having a redundant relationship with each other is attempted. Similarly, it is understood from the redundant subframe information that the subframes corresponding to RV3 and RV4 are included in the frame 15-36, and combining of the codeword blocks having a redundant relationship with each other is attempted. In a case that an error is detected even if the coded blocks included in each of the frames 15-35 and 16-36 are combined, next, combining of the coded blocks included in the subframes 15-31 to 15-34 is attempted. If the data can be correctly decoded, a response frame indicating the correct decoding is transmitted to the station apparatus 2-1. In a case that the coded blocks cannot be correctly decoded even though the combining of the coded blocks was attempted, no response frame is transmitted to the station apparatus 2-1 or a response frame (Ack, Block Ack, etc.) indicating error detection is transmitted.

### 4. Matters Common for All Embodiments

Although the communication apparatuses according to the present invention can perform communication in a frequency band (frequency spectrum) that is a so-called unlicensed band that does not require use permission from a country or a region, available frequency bands are not limited thereto. The communication apparatuses according to the present invention can exhibit its effect also in a frequency band called a white band, which is actually not used for the purpose of preventing frequency jamming and the like even though permission to use the frequency band is given from a country or a region for a specific service (e.g., a frequency band allocated for television broadcasting but is not used depending on regions), or in a shared spectrum (shared frequency band) which is expected to be shared by multiple service providers, for example.

A program operating in the radio communication apparatus according to the present invention is a program (a program for causing a computer to function) for controlling the CPU or the like to implement the functions of the aforementioned embodiments related to the present invention. In addition, information handled by these apparatuses is temporarily accumulated in a RAM at the time of processing, is then stored in various types of ROMs and HDDs, and is read by the CPU as necessary to be corrected and written. A semiconductor medium (e.g., a ROM, a non-volatile memory card, etc.), an optical recording medium (e.g., a DVD, an MO, an MD, a CD, a BD, etc.), a magnetic recording medium (e.g., a magnetic tape, a flexible disk, etc.), and the like can be examples of recording media for storing programs. In addition to implementing the functions of the aforementioned embodiments by performing loaded programs, the functions of the present invention may be implemented in processing performed in cooperation of an operating system, other application programs, and the like based on instructions of those programs.

In a case of delivering these programs to market, the programs can be stored and distributed in a portable recording medium, or transferred to a server computer connected via a network such as the Internet. In this case, the storage device serving as the server computer is also included in the present invention. A part or an entirety of the communication apparatuses in the aforementioned embodiments may be implemented as an LSI that is typically an integrated circuit. The functional blocks of the communication apparatuses may be individually implemented as chips or may be partially or completely integrated into a chip. In a case that the functional blocks are made as integrated circuits, an integrated circuit controller for controlling them is added.

The circuit integration technique is not limited to LSI, and may be realized as dedicated circuits or a multi-purpose processor. Moreover, in a case that a circuit integration technology that substitutes an LSI appears with the advance of the semiconductor technology, it is also possible to use an integrated circuit based on the technology.

Note that, the invention of the present application is not limited to the above-described embodiments. The radio communication apparatus according to the invention of the present application is not limited to the application in the mobile station apparatus, and, needless to say, can be applied to a fixed-type electronic apparatus installed indoors or outdoors, or a stationary-type electronic apparatus, for example, an AV apparatus, a kitchen apparatus, a cleaning or washing machine, an air-conditioning apparatus, office equipment, a vending machine, and other household apparatuses.

Although the embodiments of the invention have been described in detail above with reference to the drawings, a specific configuration is not limited to the embodiments, and designs and the like that do not depart from the essential spirit of the invention also fall within the claims.

### INDUSTRIAL APPLICABILITY

The present invention can be preferably used in a communication apparatus and a communication method.

### REFERENCE SIGNS LIST

1-1, 1-2, 2-1 to 2-6, 2A, 2B Radio communication apparatus
3-1, 3-2 Management range
10-1 Radio communication apparatus
10001-1 Higher layer unit
10002-1 Controller
10002a-1 CCA unit
10002b-1 Backoff unit
10002c-1 Transmission determination unit
10003-1 Transmitter
10003a-1 Physical layer frame generator
10003b-1 Radio transmitter
10003c-1 Coder
10004-1 Receiver
10004a-1 Radio receiver
10004b-1 Signal demodulator
10005-1 Antenna unit

1. A communication apparatus configured to communicate on a radio channel, the communication apparatus comprising:
a coder configured to encode a data block to generate a coded block;
a frame generator configured to generate a frame including the coded block; and
a transmitter configured to transmit the frame,
wherein the radio channel includes multiple radio sub-channels,
the coder generates one coded block or two or more coded blocks from the data block, and
the frame generator adds a header holding the same identifier to the coded blocks, and allocates the coded blocks to the radio sub-channels different from each other.

2. The communication apparatus according to claim 1, wherein the radio sub-channels have an equal bandwidth.

3. The communication apparatus according to claim 1, wherein the bandwidth of the radio sub-channels is equal to a bandwidth of preamble puncturing.

4. The communication apparatus according to claim 1, wherein the coded blocks allocated to each of the radio sub-channels are generated from the same data block and have different parity bit sequences.

5. The communication apparatus according to claim 1, wherein the coded blocks allocated to each of the radio sub-channels are generated from the same data block and have the same parity bit sequence.

6. A communication apparatus configured to communicate on a radio channel, the communication apparatus comprising:
a coder configured to encode a data block to generate a coded block;
a frame generator configured to generate a frame including the coded block; and
a transmitter configured to transmit the frame,
wherein the radio channel includes multiple radio sub-channels,
the coder generates one coded block or two or more coded blocks from the data block, and
the frame generator adds a header holding the same identifier to the coded blocks, and allocates the coded blocks to the same radio sub-channel.

7. A communication apparatus configured to communicate on a radio channel, the communication apparatus comprising:
a receiver configured to receive a frame; and
a decoder configured to decode a coded block included in the frame,
wherein the radio channel includes multiple radio sub-channels, and
the decoder combines coded blocks having the same identifier included in a header of the frame received on each of the radio sub-channels.
